(19) United States
(12) Patent Application Publication
(10) Pub. No.: US 2014/0074740 A1
(43) Pub. Date: Mar. 13, 2014

(54) SYSTEMS AND METHODS FOR PROVIDING CAREER ADVICE TO COLLEGE STUDENTS

(71) Applicants: Robert Edwin Phillips, Hampton Falls, NH (US); Monica Chandra, Boston, MA (US)

(72) Inventors: Robert Edwin Phillips, Hampton Falls, NH (US); Monica Chandra, Boston, MA (US)

(73) Assignee: TurnRight Advice Solutions, Inc.

(21) Appl. No.: 13/609,059

(22) Filed: Sep. 10, 2012

(51) Int. Cl. G06Q 50/20

(52) U.S. Cl. 705/328

(57) ABSTRACT

Methods and systems for providing career advice to a college student are disclosed. In some embodiments, the method may include receiving one or more user vocational interests of the college student and generating a user interest vector based on the one or more user vocational interests. The method may include receiving vocational interests of college affiliates, data regarding events, or data regarding job opportunities. The method may include assigning resource vocational interests to college affiliates, events, or job opportunities. The method may generate resource interest vectors associated with college affiliates, events, or job opportunities wherein each resource interest vector is based on the respective resource vocational interests. The method may compute one or more distances between the user interest vector and one or more resource interest vectors. The method may generate one or more recommendations of advice connections, events, or job opportunities based on the computed distances.

### TECHNICAL FIELD

The present disclosure relates generally to methods and systems for providing career advice to college students and, in particular, to providing career advice to college students by facilitating career network connections.

### BACKGROUND

Unique challenges face graduating college students looking to enter the job market compared to other job applicants. Some college students may have a strong sense of the field of occupation they wish to pursue but may lack substantial career experiences in that field. Other college students may not have a strong sense of what they wish to pursue or know the types of jobs that might suit or be available to them.

College students have access to some advice and resources through their college career offices and career mentorship programs. The advice coming from these sources often are narrowly based on a college student's academic major and do not present a complete picture of career possibilities that might be suitable for the college student. Advice coming from these sources is also broadly directed to the general job searching process, leaving the college student feeling lost about which specific, concrete steps to take. In addition, sometimes college students are paired with mentors or alumni that they do not know well or know how to utilize effectively. These approaches to advising college students frequently fall short of identifying the full slate of career options that may suit them and helping them obtain a job in an area of work that is likely to be satisfying to them.

Online career services also provide advice and resources to students. However, online job search services, like Monster.com, are not geared to the advantage of students and other people who have yet to build a strong resume of previous work experience. Furthermore, in a competitive job market where the applicant pool is very large, jobs often go to the applicants who have existing connections in the company or workplace, connections that students new to the job market usually do not have. Online networking services have the potential to help students make the connections, but at this time, that potential is unmet. Current networking services are either effective generalized social networking tools, popular among the student population but lacking a focus on promoting job connections, such as Facebook, or they are specifically designed for career networking but more appropriate for those who have already-established professional connections, such as LinkedIn.

Successful efforts to bridge this gap have not been realized. Online job sites and career resources geared towards college students are not effective tools to aid in building career-oriented relationships between college students and mentors with career-building experience. More often, these online sites provide a service centered on collections of advice articles, jobs listings, and generalized information that are passively presented to the end user without much engagement between the college student and potential mentors. These passive sources of information are often overwhelming, unengaging, and not very relevant to an individual college student's specific situation and needs.

### SUMMARY

The present disclosure is directed to a computer-implemented method of providing career advice to a college student. The method may include receiving, by a computing device associated with the user, one or more vocational interests of the college student and generating, by an interest vector generator, a user interest vector based on the one or more user vocational interests. The method may include receiving, by a computing device associated with one or more college affiliates, any of one or more vocational interests of one or more college affiliates, data regarding one or more events, or data regarding one or more job opportunities. The method may also include assigning one or more resource vocational interests to any college affiliates, events, or job opportunities and generating, by the interest vector generator, one or more resource interest vectors associated with the one or more college affiliates, events, or job opportunities. Each resource interest vector may be based on the resource vocational interests of the respective one or more college affiliates, events, or job opportunities. The method may include computing, by a comparator module, one or more distances between the user interest vector and the one or more resource interest vectors. The method may generate one or more recommendations of one or more advice connections from among the college affiliates, events, or job opportunities based on the one or more computed distances.

In some embodiments, the method may also include generating a visual roadmap related to at least one recommended advice connection, and providing an option to follow an advice stream of at least one recommended advice connection.

According to various embodiments, the present disclosure is also directed to a system for providing career advice to college students. The system may include an interest vector generator module configured to receive user vocational interests associated with college students and resource vocational interests associated with resources comprising at least one of college affiliates, events, and job opportunities. The interest vector generator may compute user interest vectors and resource interest vectors based on the user vocational interests and resource vocational interests respectively. The system may include one or more databases for storing user interest vectors and resource interest vectors associated with their respective users and resources. The system may also include a comparator module configured to compute distances between user interest vectors and resource interest vectors. The system may also include a recommendation engine module configured to generate one or more recommendations of one or more resources based on computed distances between user interest vectors and resource interest vectors.

In some embodiments, the system may further include a visual roadmap generator configured to generate one or more visual roadmaps related to one or more recommended advice connections and an advice stream module configured to generate one or more advice streams related to one or more advice connections.

### BRIEF DESCRIPTION OF THE DRAWINGS

The drawings are not necessarily to scale. Instead, emphasis is generally placed upon illustrating the principles of the inventions described herein. It is to be understood that the following detailed description is exemplary and explanatory only and is not restrictive of any invention, as claimed. The accompanying drawings, which are incorporated in and constitute a part of this specification, illustrate several embodiments consistent with the inventions and together with the description, serve to explain the principles of the inventions. In the drawings:

FIG. 1 shows a block diagram of an exemplary career advice system in accordance with some of the disclosed embodiments;

FIGS. 2(A)-(M) show exemplary computer-generated screen shots of an exemplary career advice system in accordance with some of the disclosed embodiments; and

FIGS. 3(A)-(D) show flowcharts of exemplary methods for providing career advice to a college student in accordance with some of the disclosed embodiments.

### DETAILED DESCRIPTION

The following detailed description refers to the accompanying drawings. Wherever possible, the same reference numbers are used in the drawings and the following description to refer to the same or similar parts. Also, similarly-named elements perform similar functions and are similarly designed, unless specified otherwise. Numerous details are set forth to provide an understanding of the embodiments described herein. The embodiments may be practiced without these details. In other instances, well-known methods, procedures, and components have not been described in detail to avoid obscuring the embodiments described. While several exemplary embodiments and features are described herein, modifications, adaptations, and other implementations are possible, without departing from the spirit and scope of the invention. Accordingly, the following detailed description does not limit the invention. Instead, the proper scope of the invention is defined by the appended claims.

This application pertains to systems and methods for providing career advice to users. In some exemplary embodiments, the systems and methods may provide career advice to users who are college students. As used herein, the term “college students” refers to those who are attending, have attended, or will attend in the future one of a college, university, vocational school, and any other educational institutions or communities. In various embodiments, career advice may come from college affiliates of the educational institution or community to which the college student belongs. As used herein, the term “college affiliates” includes alumni/ae, professors, administrators, board members, other college students, and other members of the educational institution/community of the college student, including industry experts who have a relationship with the educational institution/community. For purposes of this disclosure, users of the system and method may be college students, college affiliates, and/or any combination of the two. Also for purposes of this disclosure, when discussing methods and systems of providing career advice with respect to one of many college students, all others of the many college students may be considered college affiliates and potential sources of advice to the one college student.

The system may include receiving vocational interests from a set of users including college students and college affiliates, and utilizing these vocational interests to generate specific recommendations of occupations, advice connections, events, and job opportunities to a college student. The vocational interests for each user may be received in various forms for different embodiments. In some embodiments, the vocational interests may be received through a questionnaire. The questionnaire may pose numerous questions ranging from, for example, what activities the user enjoys to whether the user is comfortable with certain kinds of concepts or information to what behavioral tendencies the user exhibits. Similar questionnaires are used in, for example, Myers-Briggs Type Indicator tests, Keirsey Temperament Sorters, Campbell Interest and Skill Surveys, Holland method assessments and other personality/skills assessments. In some embodiments, vocational interests may reflect occupational interests. In various embodiments, the vocational interests may be received by a user selecting from a list of occupational interests a subset of occupational interests that the user may have. For example, vocational interests of a user may be determined from a list of interests including Architecture, Engineering, Business, Financial, Computer and Information Technology, Consulting, Entertainment, Sports, Food Preparation and Serving, Installation, Maintenance, Repair, Life Science, Physical Science, Social Science, Marketing, Advertising, Media and Communication, Office and Administrative Support, Politics, Public Service, Protective Service, Sales, Arts and Design, Community and Social Service, Construction and Extraction, Education, Training, Library, Farming, Fishing, Forestry, Healthcare, Legal, Management, Math, Military, Personal Care and Service, Production, Real Estate, and/or Transportation and Material Moving. In some embodiments, the list may not include some of these vocational interests, may include other additional vocational interests, or include a completely different set of vocational interests not mentioned. In other embodiments, vocational interests may also be other types of interests besides occupational interests. For instance, vocational interests may describe social interests, leadership interests, service interests, or any other interests that may impact the choice of or success in a vocation. Examples of social interests may be whether a user is interested in collaborative work or individual work, enjoys talking with many different people or prefers to have contact with a select core group, or is good at handling interpersonal conflicts. Example of leadership interests may be whether a user seeks leadership roles, can follow leadership, prefers not to report to leadership, or prefers certain leadership styles.

In various embodiments, to generate specific recommendations of occupations, advice connections, events, and job opportunities, a multidimensional indicator of a user's personality or interests may be generated for each user based on vocational interests received from each user. For example, in embodiments that utilize a questionnaire or assessment test associated with, for example, the Myers-Briggs or Holland assessments, the user's answers to the test may generate a four-element code (in the example of Myers Briggs), a six-element code (in the example of Holland), or any other representative code derived from the user's interests. In embodiments utilizing the Holland assessment, for example, the assessment test may result in a score for each of six interest categories defined by the Holland assessment. The interest categories may be identified as Realistic (R), Investigative (I), Artistic (A), Social (S), Enterprising (E), and Conventional (C). These interest categories may each identify one facet of the user's personality or interests, and the scores for each interest category may indicate how much of the user's personality is characterized by the particular category. The six scores for these six interest categories can be thought of as making up a multidimensional indicator, where each dimension corresponds to one of the six interest categories. In some embodiments, the multidimensional indicator may be represented as a multidimensional vector, herein referred to as an interest vector. For example, the Holland assessment may produce a six-dimensional interest vector, [(R), (I), (A), (S), (E), (C)], where each element in the vector contains a score corresponding to the strength of the corresponding interest category in the user's personality or interests.

In some embodiments, interest vectors may simply convey whether each of the categories is associated with a user. For example, the user may be characterized as being Investigative and Artistic and have a corresponding interest vector of [0, 1, 1, 0, 0, 0], for the example in which Holland interest categories are being utilized and a Holland interest vector is defined as [(R), (I), (A), (S), (E), (C)]. In some embodiments, the interest vector may be normalized, so that in the example above, the user's interest vector may be [0, 1/\sqrt{2}, 1/\sqrt{2}, 0, 0, 0]. In some embodiments the user may be associated with one interest category, three interest categories, or any other number of interest categories. For example, the user may be characterized as Investigative, Enterprising, and Conventional, and be assigned an interest vector of [0, 1, 0, 0, 1, 1] or a normalized interest vector of [0, 1/\sqrt{3}, 0, 0, 1/\sqrt{3}, 1\sqrt{3}]. In other embodiments, the interest vector may convey more than just a binary indication of whether an interest category may be associated with the user. Based on the scores that may be generated for each of the Holland interest categories, for example, the user may be characterized as being Realistic-1, Investigative-5, Artistic-6, Social-2, Enterprising-3, and Conventional-1. In this example, the user's interest vector may be [1, 5, 6, 2, 3, and 1], and the normalized interest vector may be [1/\sqrt{76}, 5/\sqrt{76}, 61/\sqrt{76}, 2/\sqrt{76}, 3/\sqrt{76}, 1/\sqrt{76}]. It is conceivable that other conventions of forming interest vectors may be used.

In some embodiments that include receiving the user's vocational interests by the user selecting from a list of vocational interests, each of the vocational interests may be associated with a corresponding interest vector. For example, if using Holland assessment interest categories, the vocational interest of Food Preparation may be characterized as Realistic and Conventional. Therefore, the interest vector for Food Preparation may be [1, 0, 0, 0, 0, 1], for the example in which a Holland interest vector is defined as [(R), (I), (A), (S), (E), (C)]. As another example, the vocational interest of Library may be characterized as Conventional, Social, and Enterprising, and may have an interest vector in the Holland categories of [0, 0, 0, 1, 1, 1]. In some embodiments, the interest vectors for the vocational interests may be normalized interest vectors, as discussed with regards to interest vectors for users. In some embodiments, the interest vectors may include values of various scores indicating the strength of association between the vocational interests and the interest categories, as opposed to simple binary indications, as discussed above with respect to interest vectors for users.

In some embodiments that utilize a list of vocational interests and each vocational interest is associated with an interest vector, a user's interest vector may be determined from the vocational interests the user chooses from the list of vocational interests. If the user selects one vocational interest, the user may be assigned the interest vector corresponding to that vocational interest. If the user selects more than one vocational interest, the user may be assigned an interest vector that is an average of the interest vectors for the more than one vocational interests. For example, if the user selects Food Preparation and Library as their vocational interest, the user may be assigned an interest vector of [½, 0, 0, ½, ½, 1], which is an average of the interest vector for the vocational interests Food Preparation and Library. In some embodiments, the user's interest vector may be this averaged interest vector normalized.

In various embodiments, interest vectors may also be assigned to events, occupations, job opportunities and/or other career-related items, in addition to users. Based on the various interest vectors assigned to various entities and items, recommendations of advice connections, event, occupations, job opportunities, and/or other useful career-related items may be provided to users, for example, a college student, as career advice.

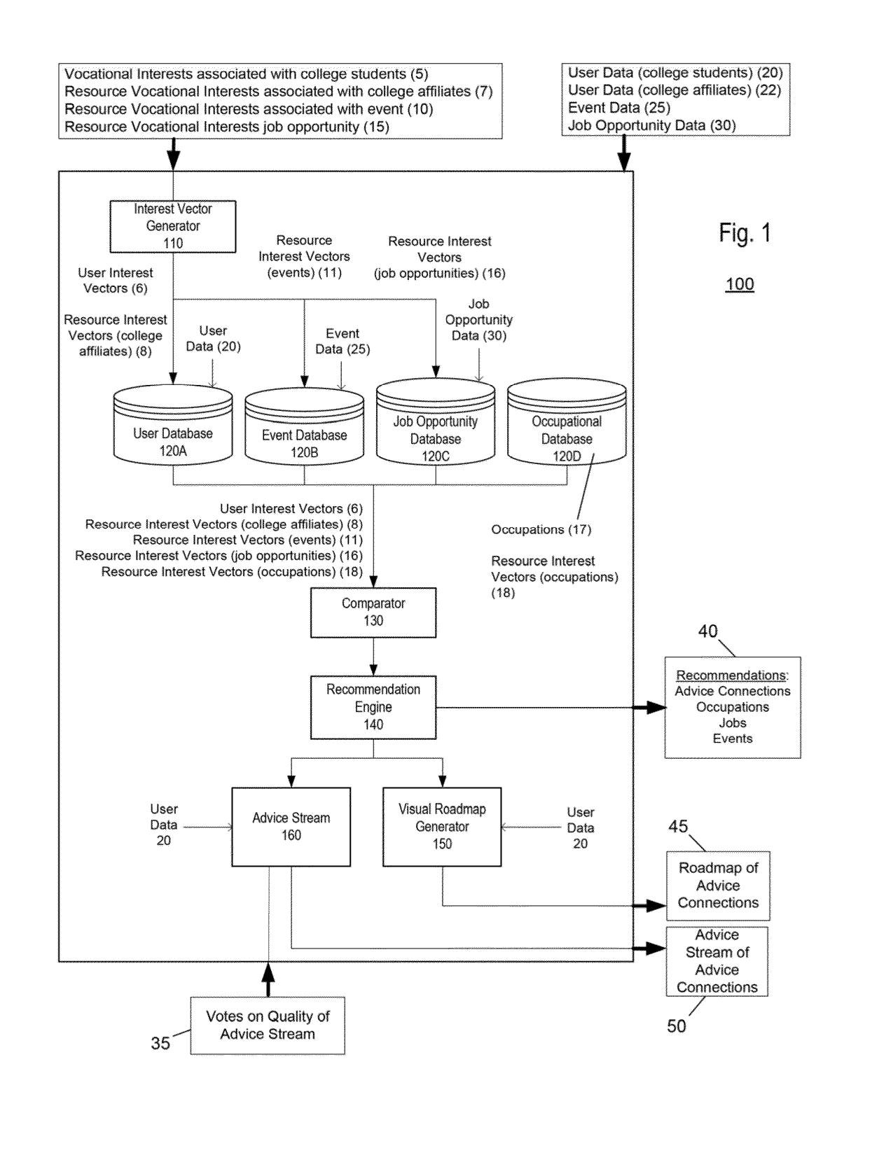

FIGS. 1, 2, and 3 illustrate an exemplary system and an exemplary method for providing career advice consistent with concepts disclosed herein. FIGS. 1, 2, and 3 will now be discussed in more detail. In the following discussions of exemplary embodiments, interest vectors are based on Holland assessment codes. However, the disclosure is by no means limited to the use of the Holland assessment framework.

FIG. 1 shows a block diagram of an exemplary system 100 for providing career advice to college students. System 100 includes an interest vector generator 110, databases 120(A)-(D), comparator 130, recommendation engine 140, visual roadmap generator 150, and advice stream module 160. Further, system 100 receives various inputs including vocational interests 5, 7, 10, and 15, user data 20 and 22, event data 25, job opportunity data 30, and votes on quality of advice stream 35, and generates various outputs including recommendations 40, roadmap of advice connections 45, and advice stream of advice connections 50.

Interest vector generator 110 may receive vocational interests 5 associated with users who are college students and resource vocational interests 7 associated with users who are college affiliates. In some embodiments, vocational interests 5, 7 may be selected from a predefined list of vocational interests. In some embodiments, the list of vocational interests may be occupational interests similar to those described above. In some embodiments, each vocational interest 5, 7 may be associated with an interest vector. The interest vectors may be Holland interest vectors, or any other type of interest vectors. In some embodiments, interest vector generator 110 assigns a user interest vector 6 or resource interest vector 8 to college students or college affiliates respectively based on the vocational interests 5 or 7 that are provided by the college students or college affiliates. In some embodiments, the user may provide more than one vocational interests, and interest vector generator 110 may assign an interest vector 6, 8 to the user based on an average of the interest vectors associated with the more than one vocational interests 5, 7.

In some embodiments, interest vector generator 110 may output the interest vectors 6, 8 associated with the users to user database 120A. User database 120A may store the user's corresponding interest vector 6, 8 in an associated manner. User database 120A may also include other user data 20 and 22 for college students and college affiliates respectively that is used by system 100, e.g., detailed user information, user advice, etc, as discussed later. In some embodiments, the interest vector 6, 8 may be updated at any time a new set of vocational interests 5, 7 is chosen by a user. Interest vector generator 110 may generate and assign a new interest vector 6, 8 based on the new set of vocational interests 5, 7 and store the updated interest vector 6, 8 in user database 120A.

An advantage to assigning interest vectors to users based on a select number of vocational interests is that a user, such as a college student, is not forced into a rigid, fixed notion of what they might be interested in. For example, if a college student realizes, at some time later, that they are not at all interested in vocational interest Finance, as they might have first thought when inputting their vocational interests 5, they can easily go back and remove Finance and perhaps add another vocational interest 5. As a result, their assigned user interest vector 6 may significantly change, as determined by interest vector generator 110, and the recommendations provided to them by system 100 may also significantly change as a result.

In various embodiments, some of the users who are using system 100 may be college affiliates with already-established careers, for example, alumni/ae, professors, administrators, and industry experts. In some embodiments, these college affiliates may choose one or more resource vocational interests 7 that reflect their actual occupation or career. In other embodiments, the college affiliates may also choose resource vocational interests 7 in which they are interested or might have pursued. In this way, the interest vectors 8 generated for the college affiliates may reflect not just the occupations of the college affiliates, but also their general interests or personalities that may not otherwise be encompassed by their occupation. In some embodiments, this may provide advantages in matching a user such as a college student with an affiliate as a recommended advice connection. For example, a college student may believe that they want to pursue a career in Education, and specifically as a grade school teacher, but may include a couple of other vocational interests along with Education as being representative of their interests. As a result, the college student may be assigned a corresponding user interest vector 6. On the other hand, a college affiliate may have a long, successful career in Politics. However, the college affiliate may also indicate a couple of other vocational interests 7 that, while they do not reflect the college affiliate's actual occupation, are representative of the college affiliate's interests. It may be that the college affiliate's resource interest vector 8, calculated from the combination of Politics and the couple of other vocational interests 7 chosen by the college affiliate, closely matches the user interest vector 6 of the college student. Consequently, as discussed in more detail later in this disclosure, system 100 may recommend the college affiliate as a possible useful connection for the college student. The college student and/or the college affiliate may have never considered this connection based on the college student's initial idea of being a grade school teacher. However, it may be that the similarities in interests of the college student and the college affiliate, as indicated by the closeness of their interest vectors, warrant the college student's considering the career choices made by the college affiliate. This college affiliate may also be a potential mentor or source of advice, and may be suggested to the college student as a possible advice connection, as discussed later in the disclosure.

In various embodiments, system 100 may receive input of one or more events 25. In some embodiments, events 25 may be provided by a user, for example, a college affiliate. In other embodiments, events 25 may be automatically retrieved or transmitted from external events listings on other databases or sources outside system 100. Events 25 may be training events, networking events, educational opportunity events, career fair events, and/or any other learning events that may be useful for users in their career searches. In some embodiments, when a user, such as a college affiliate, inputs an event 25 into system 100, the user also identifies one or more resource vocational interests 10 that correspond to the event. For example, if event 25 is a lecture on glass buildings by a design consultant, the user may associate event 25 with resource vocational interests Architecture, Construction, and Art/Design. In other embodiments (not shown), event 25 may be automatically assigned resource vocational interests 10 based on the resource vocational interests 7 associated with the college affiliate inputting event 25. In some embodiments, after system 100 receives the one or more resource vocational interests 10 that correspond to the event, interest vector generator 110 may assign a resource interest vector 11 to the event 25 based on the associated resource vocational interests 10, in a similar manner interest vector generator 110 assigned an interest vector 6, 8 to a user. In some embodiments, interest vector generator 110 may output resource interest vectors 11 associated with the event 25 to event database 120B. Event database 120B may store all of the events 25 of system 100, and for each event 25, database 120B may store the event's corresponding resource interest vector 11 in an associated manner. Inputs of events 25 may include any data about the events, including, e.g., name, location, detailed description, etc., which may be stored in event database 120B.

In various embodiments, system 100 may receive one or more job opportunities 30 as inputs. In some embodiments, job opportunities 30 may be provided by a user, for example, a college affiliate. In other embodiments (not shown), job opportunities 30 may be automatically retrieved or transmitted from external job opportunities listings on other databases or sources outside system 100. Job opportunities 30 may include job openings, internships, volunteer opportunities, and/or any other opportunities for obtaining work experience. In some embodiments, when a user inputs a job opportunity 30 into system 100, the user also identifies one or more resource vocational interests 15 that correspond to job opportunity 30. In some embodiments (not shown), the one or more resource vocational interests 15 may be automatically assigned to job opportunity 30 based on available databases, for example, the O*NET database (Occupational Information Network), which is discussed in further detail below. In other embodiments (not shown), job opportunities 30 may be automatically assigned resource vocational interests 15 based on resource vocational interests 7 associated with a college affiliate who is inputting job opportunity 30. In various embodiments, interest vector generator 110 may output resource interest vectors 16 associated with job opportunities 30 to job opportunity database 120C. Job opportunity database 120C may store all of the job opportunities 30 of system 100, and for each job opportunity 30, database 120C may store the job opportunity's corresponding resource interest vector 16 in an associated manner. Inputs of job opportunities 30 may include any data about the job opportunities, including, e.g., description, deadline for applying, etc., which may be stored in job opportunity database 120C.

In some embodiments, system 100 may include user database 120A, event database 120B, and job opportunity database 120C, populated with at least user and resource interest vectors 6, 8, 11, and 16 generated by interest vector generator 110. In some embodiments, system 100 may also include an occupational database 120D. In some embodiments, occupational database 120D may similarly be populated with interest vectors generated by interest vector generator 110 (not shown). For example, one or more occupations 17 may be input into system 100 and associated with one or more vocational interests. Interest vector generator 110 may assign each occupation 17 a resource interest vector 18 based on the resource vocational interests associated with each occupation 17. Interest vector generator 110 may output a resource interest vectors 18 to occupation database 120D, which may store the occupations 17 and corresponding resource interest vectors 18 in an associated manner.

Alternatively, in other embodiments, such as the one depicted in FIG. 1, system 100 may have access to an occupational database 120D that is a publicly available database such as the O*NET database. The O*NET database, a resource developed by the U.S. Department of Labor/Employment and Training Administration (USDOL/ETA), contains accumulated information associating job occupations with Holland codes that system 100 can interpret as Holland interest vectors, thereby providing a source of resource interest vectors 18 associated with occupations 17. In some embodiments that have access to an occupational database 120D that is already populated with resource interest vectors 18, it may be that system 100 does not need to receive inputs of occupations 17 and associated vocational interests, and interest vector generator 110 does not need to generate resource interest vectors 18. In fact, it is conceivable that any of databases 120A, 120B, 120C, and 120D may be prepopulated databases that system 100 only needs to access, and that system 100 may not need to receive user, event, job opportunity, and/or occupation inputs or to generate the corresponding interest vectors.

For purposes of this disclosure, college affiliates, events, and job opportunities are considered resources, their corresponding vocational interests 7, 10, and 15 are referred to as resource vocational interests, and their corresponding interest vectors 8, 11, and 16 are referred to as resource interest vectors. For purposes of this disclosure, occupations are also considered resources, and their corresponding interest vectors 18 are also referred to as resource interest vectors.

Comparator 130 may receive interest vectors from user database 120A, event database 120B, job opportunity database 120C, and/or occupational database 120D, and compare the various interest vectors. In various embodiments, comparator 130 may perform comparisons between user interest vectors 6 of college students and resource interest vectors 8 of college affiliates. In some embodiments, comparator 130 may perform comparisons between user interest vectors 6 and resource interest vectors for events 11, resource interest vectors for job opportunities 16, and/or resource interest vectors for occupations 18.

In some embodiments, comparator 130 may compare two interest vectors by computing a distance between the interest vectors. In some embodiments, computing the distance may require that the interest vector be normalized interest vectors. In some embodiments, the distance between two (normalized) interest vectors, when one interest vector x is represented by [x₁, x₂, x₃, x₄, x₅, x₆] and another interest vector y is represented by [y₁, y₂, y₃, y₄, y₅, y₆], is:

$$distance ( [ x , y ] ) = \sqrt{\begin{matrix}{( {x}_{1} - {y}_{1} )}^{2} + {( {x}_{2} - {y}_{2} )}^{2} + {( {x}_{3} - {y}_{3} )}^{2} + \\ {( {x}_{4} - {y}_{4} )}^{2} + {( {x}_{5} - {y}_{5} )}^{2} + {( {x}_{6} - {y}_{6} )}^{2}\end{matrix}} \qquad Eq 1$$

In some embodiments, the distance calculated by comparator 130 may indicate how closely two interest vectors match. A small distance indicates a better match than a large distance. Therefore, in some embodiments, when a college student's user interest vector 6 is a small distance away from a college affiliate's resource interest vector 8, the college student may have a similar interest as the college affiliate. When a college student's user interest vector 6 is a small distance away from an resource interest vector for an event 11, it may be an indication that the college student may find the corresponding event 25 useful to attend in trying to find a job or career in the college student's interest areas. Likewise, when the user interest vector 6 is a small distance away from a resource interest vector for a job opportunity 16 or a resource interest vector for an occupation 18, the corresponding job opportunity 30 or occupation 17 may be a promising option for the college student to consider, explore, or seek mentoring resources for. In various embodiments, any other methods of comparing interest vectors as is known in the art may be used.

Comparator 130 may perform distance or any other comparison computations at various times, according to various embodiments. Comparator 130 may be configured to run comparison computations at predetermined intervals, in response to specific actions by the users of system 100, at the request of a system administrator, after determination of certain conditions being met, or in any other manner. For example, comparator 130 may run comparisons between all interest vectors 6, 8 every day or at any other regular time interval, or for every time a certain number of users have updated or entered their vocational interests 5, 7. In another example, system 100 may perform comparisons on a subset of interest vectors 6, 8 where the subset is determined based on a coarse presorting or may perform comparisons for a different subset every hour, until all users have been compared to all other users to distribute the computational resources being used for the comparison. In some embodiments, comparisons between user interest vectors 6 and resource interest vectors for events 11 are performed every time an event 25 is input into system 100. In other embodiments, comparisons may be performed when a user requests system 100 to search for matches (between the user's interests and events, other users' interests, job opportunities, and/or occupations). Other variations may be used to determine when comparator 130 performs calculations to compare interest vectors, as known in the art.

Comparator 130 may store the results of the comparisons it has performed in tables, databases, and/or by any other means known in the art. Comparator 130 may output one or more computed comparisons to recommendation engine 140. In some embodiments, recommendation engine 140 may generate recommendations 40 based on results from comparator 130 and output them to one or more users. In various embodiments, recommendation engine 140 may generate a recommendation 40 for a user by identifying college affiliates 22, events 25, job opportunities 30, and occupations 17 with corresponding resource interest vectors 8, 11, 16, and 18 that are a small distance away from the user interest vector 6 of the college student. For example, recommendation engine 140 may output a recommendation of an advice connection to a user, for example, a college student, where the advice connection is another user of system 100, for example, a college affiliate. The college affiliate may be alumni/ae, professors, administrators, other college students, industry experts, and/or any other users that may have an established career or prior career-building experiences. In various embodiments, the advice connection that recommendation engine 140 outputs to the college student may be a college affiliate who has a resource interest vector 8 with the shortest distance from the user interest vector 6 of the college student. In other embodiments, recommendation engine 140 may output more than one advice connection. For example, recommendation engine 140 may provide thirty recommended advice connections, and these advice connections may be the thirty college affiliates that have the thirty resource interest vectors 8 with the shortest distances to the user interest vector 6 of the college student. These advice connections are recommended to the college student as users who may be able to provide guidance and be role-models for the college student based on similar interests as reflected in the interest vectors of the advice connections and college students. In a similar manner, recommendation engine 140 may recommend events 25, job opportunities 30, and occupations 17 based on the results of comparator 130. Recommendation engine may output these recommendations 40 to the user as events, job opportunities, and occupations that may help the college student in their job or career search because of how strongly they align with the interests of the college student.

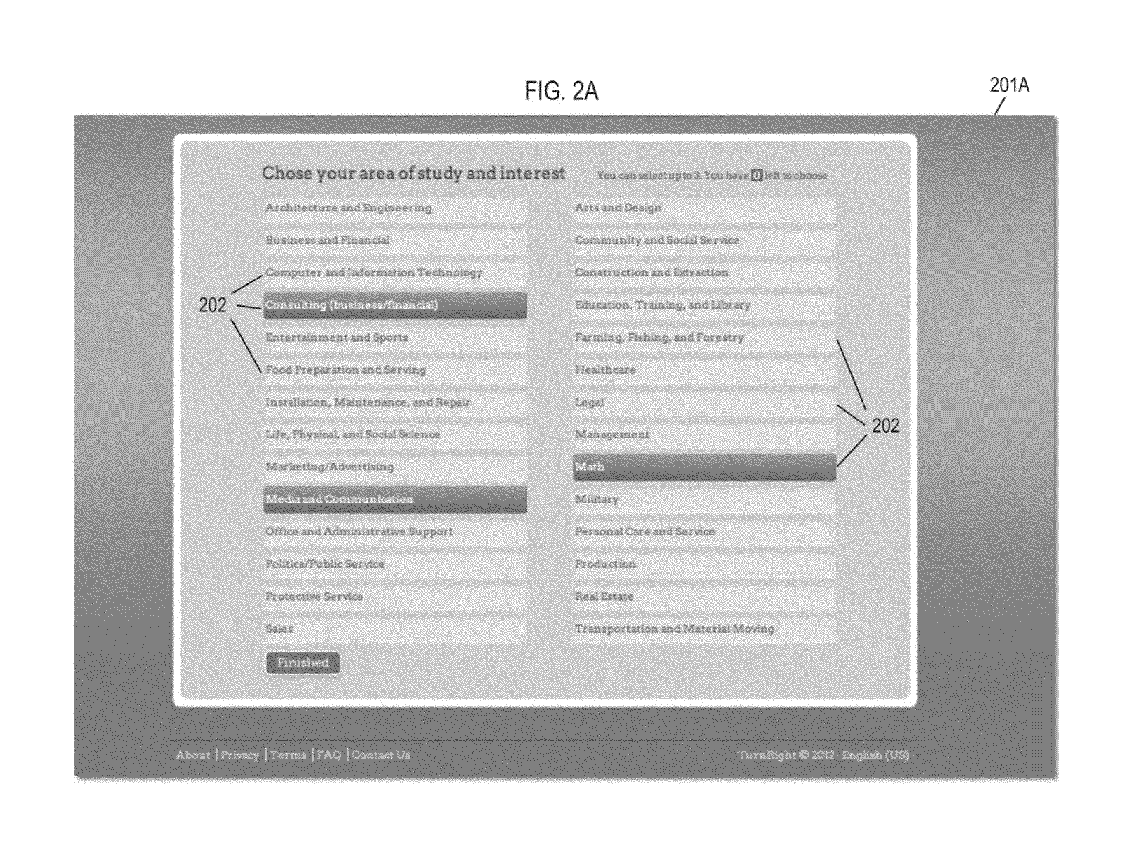

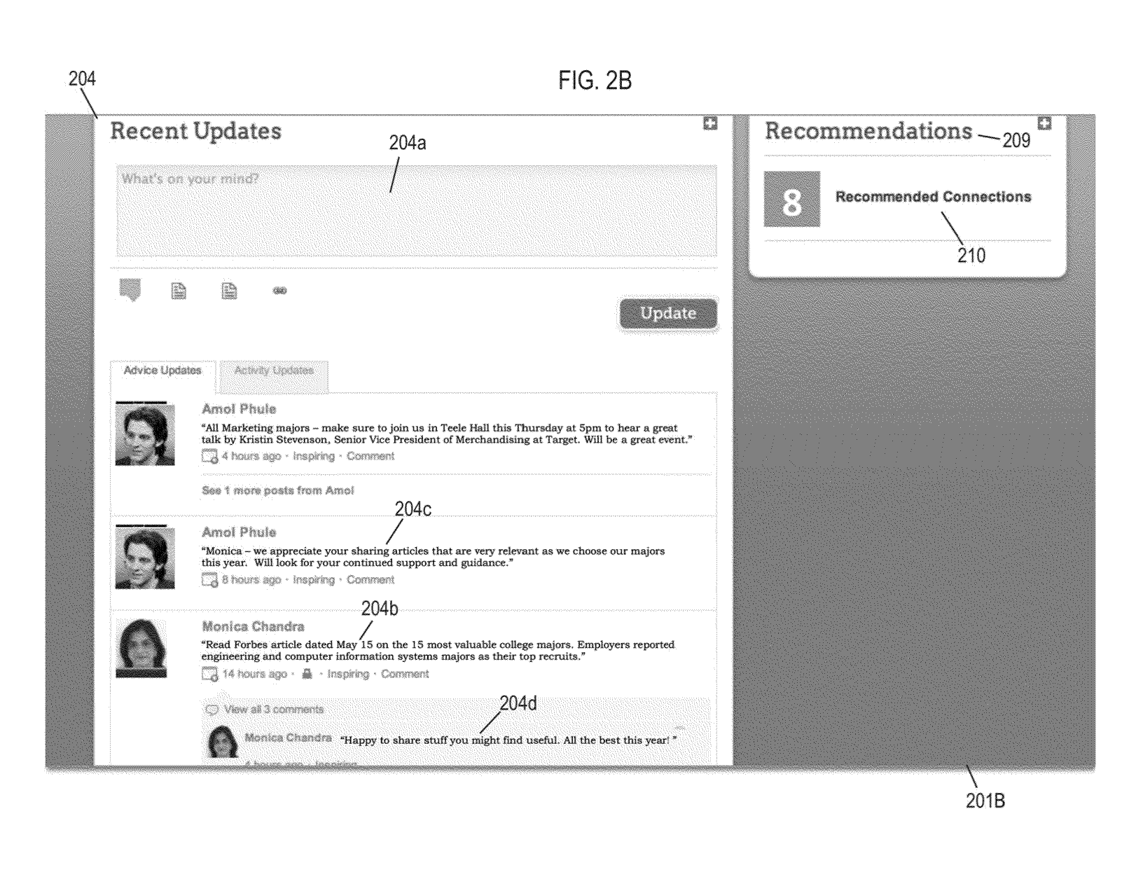

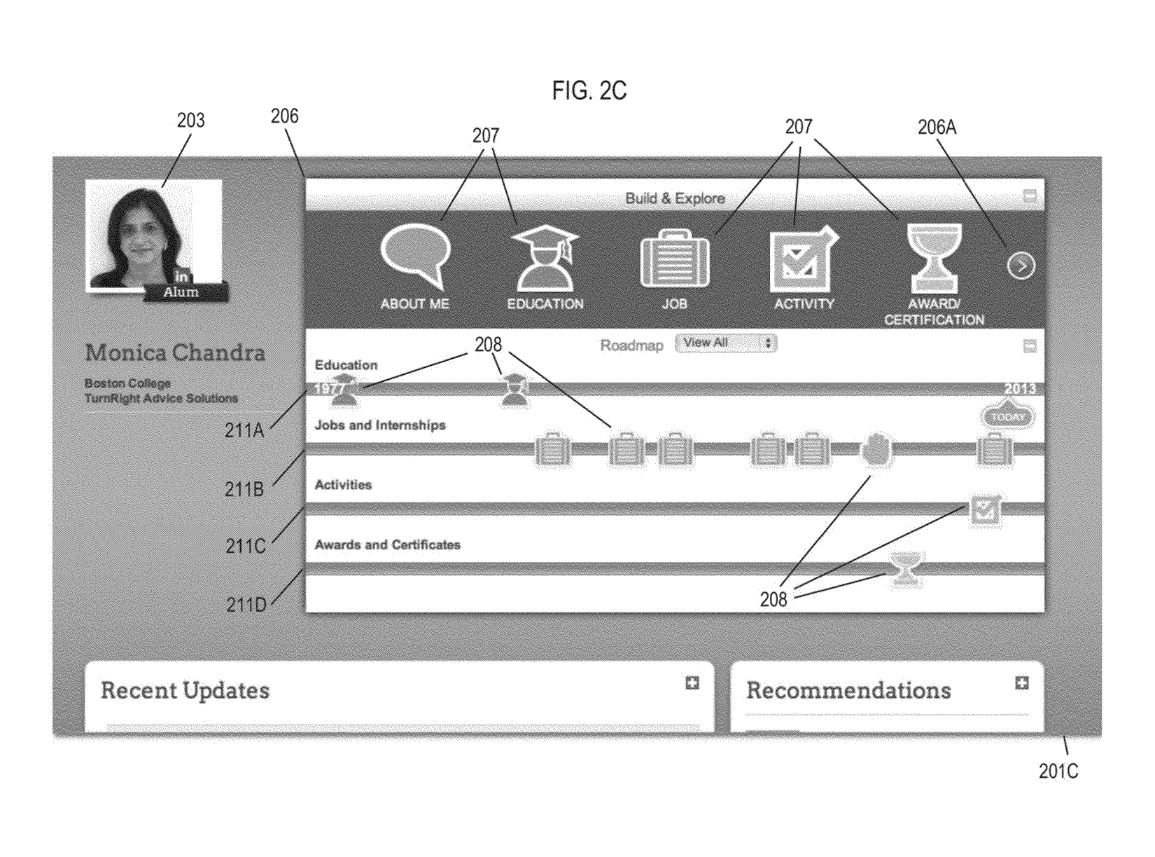

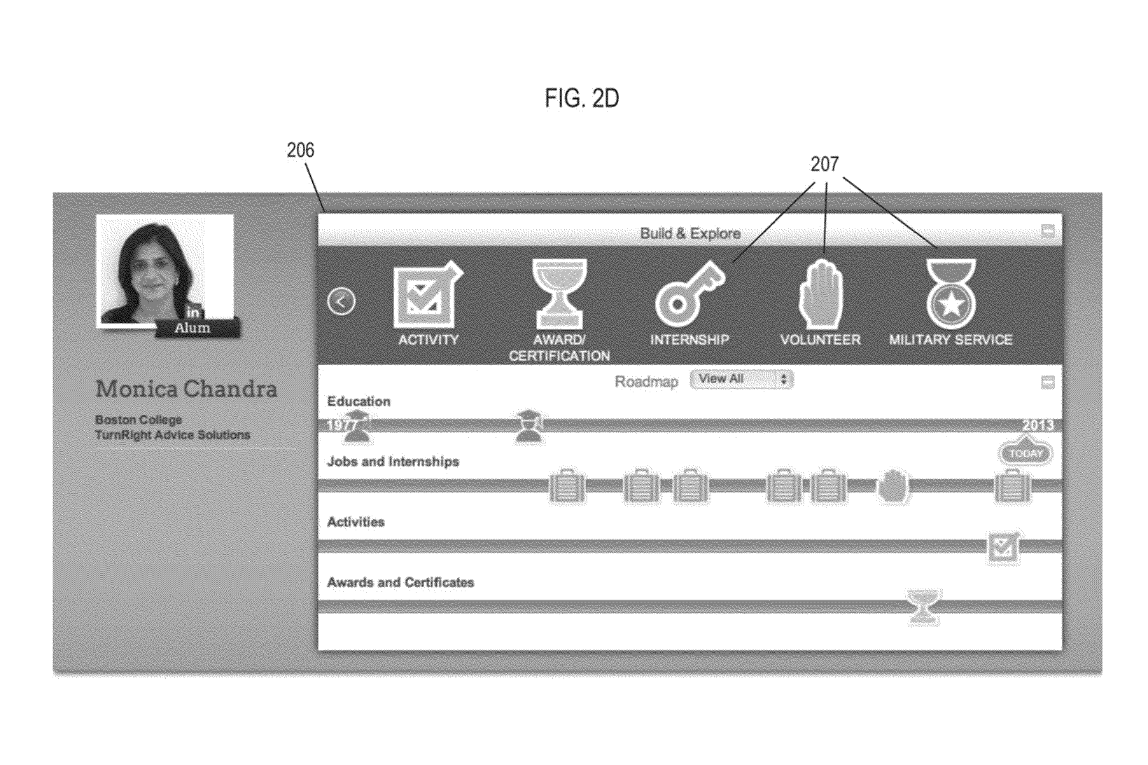

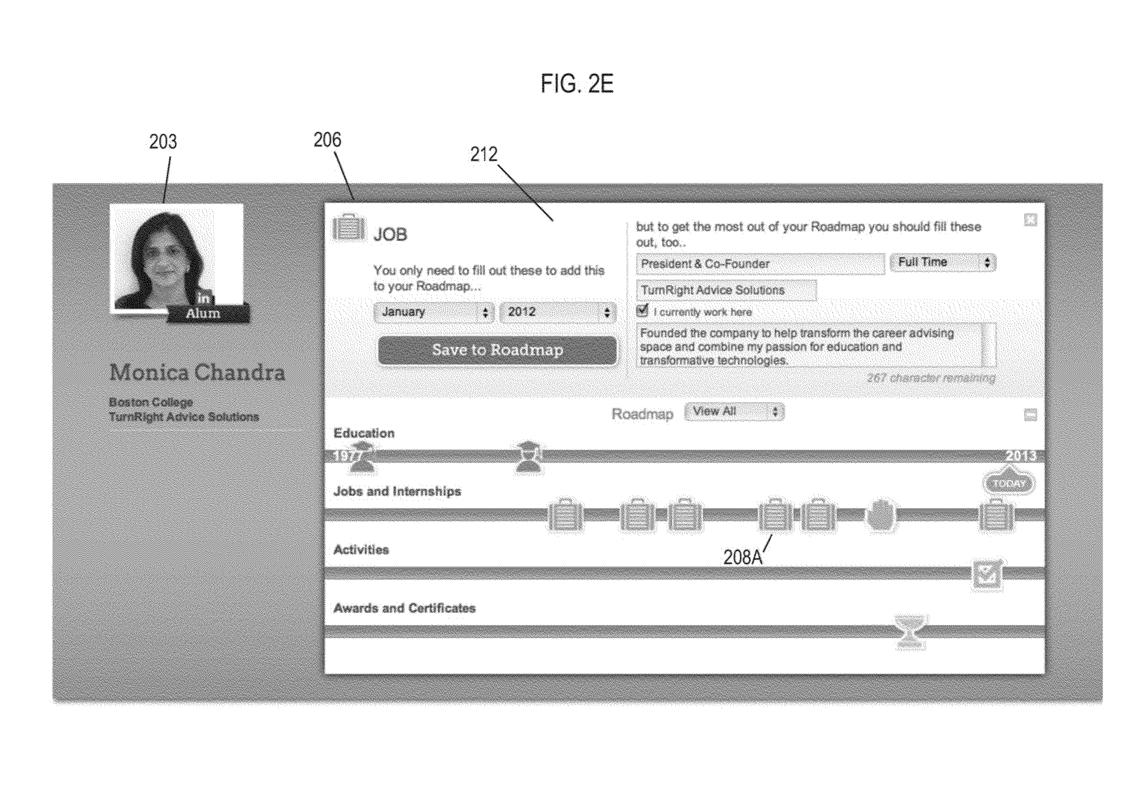

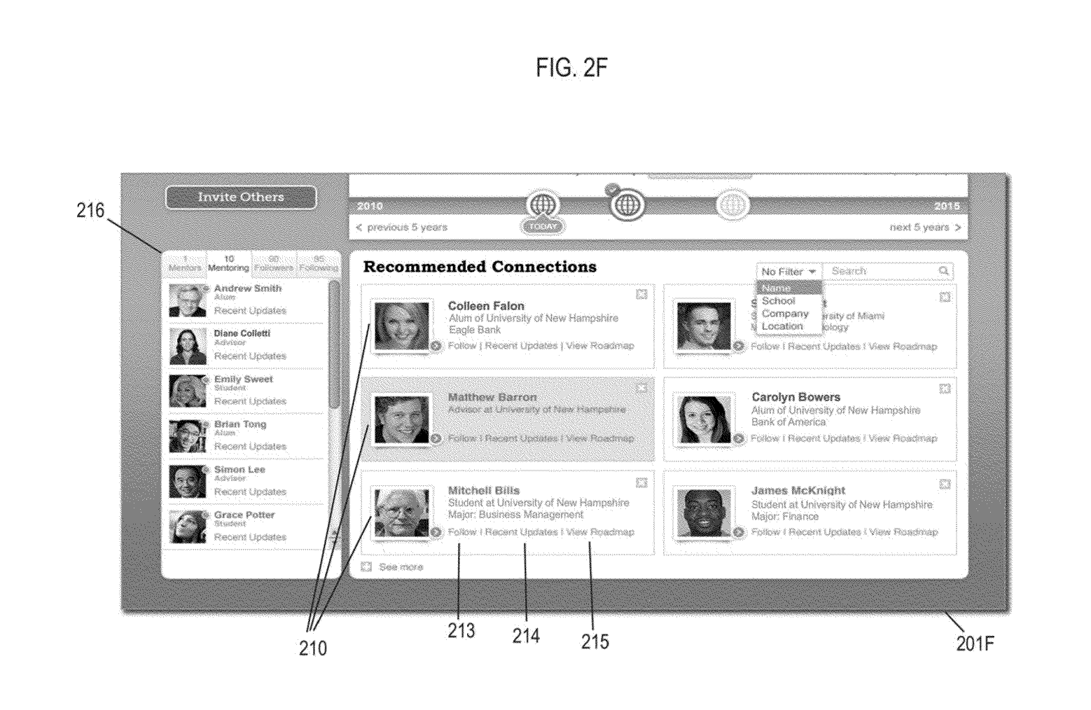

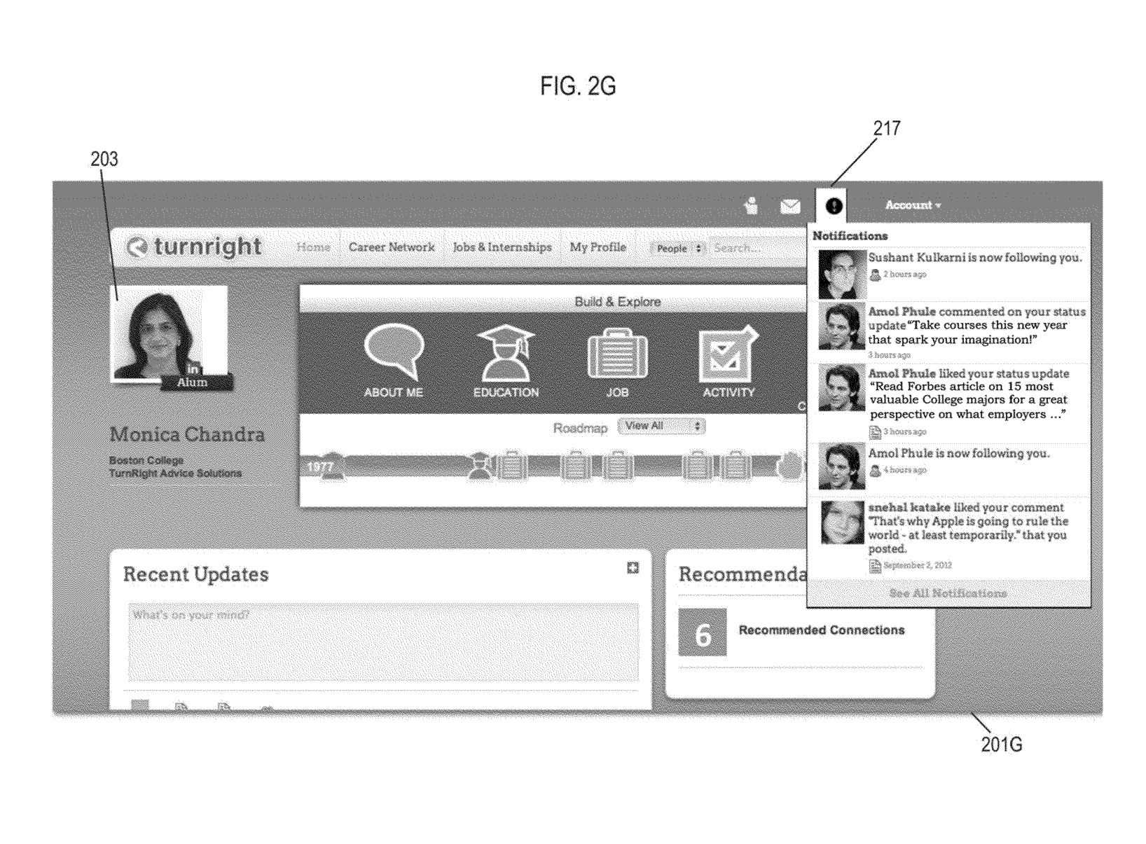

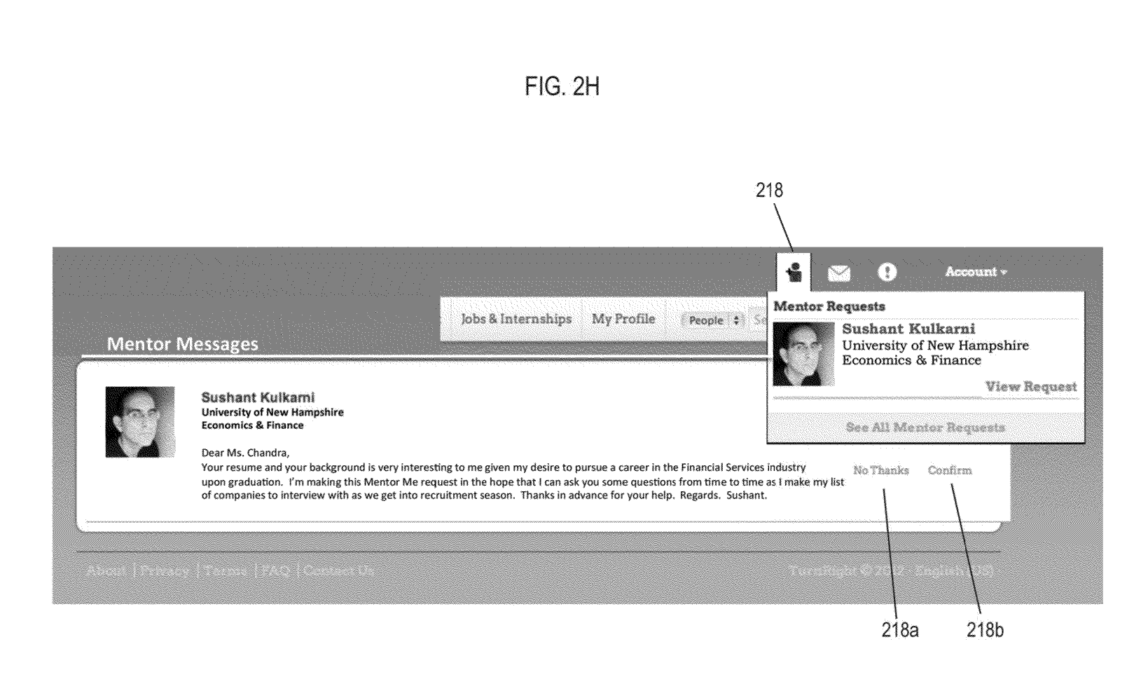

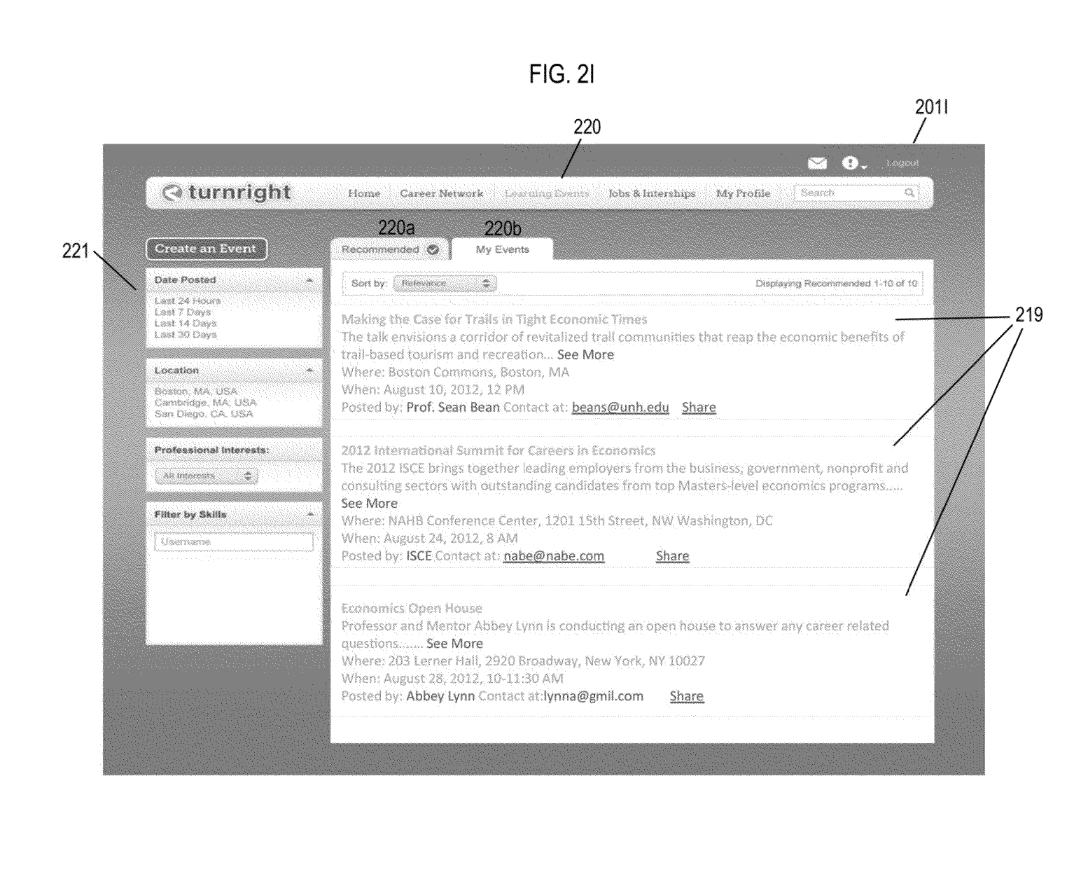

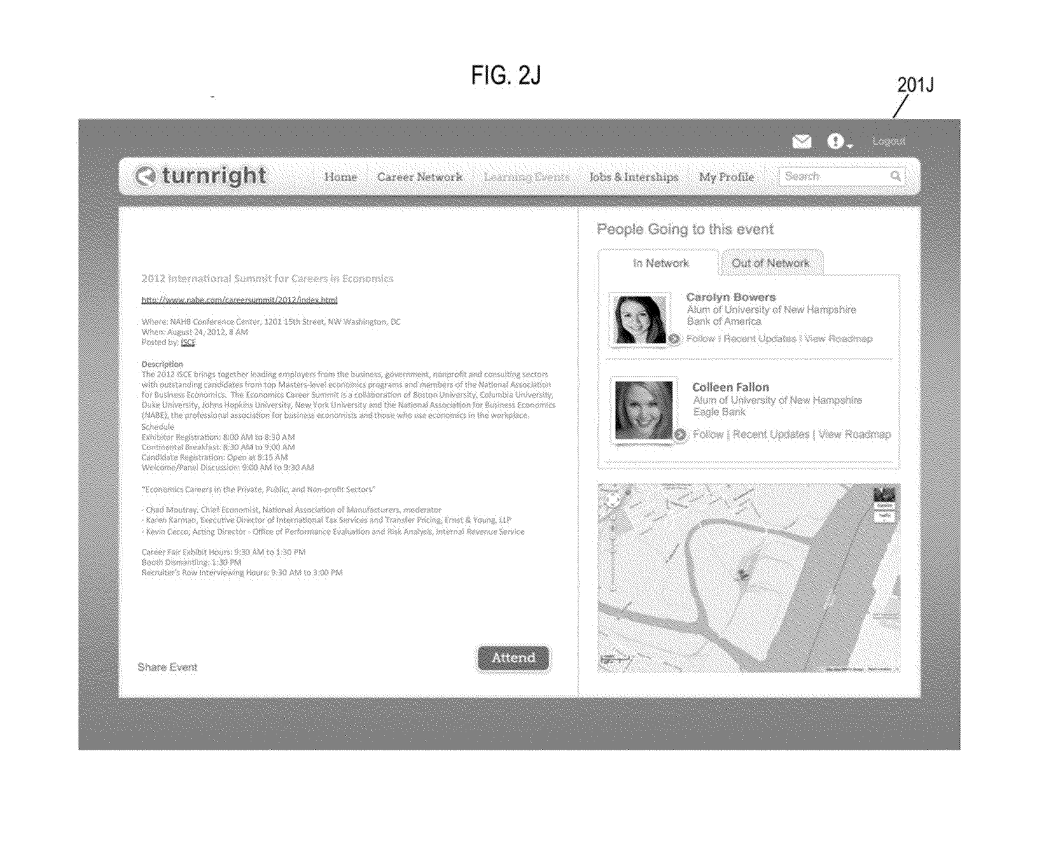

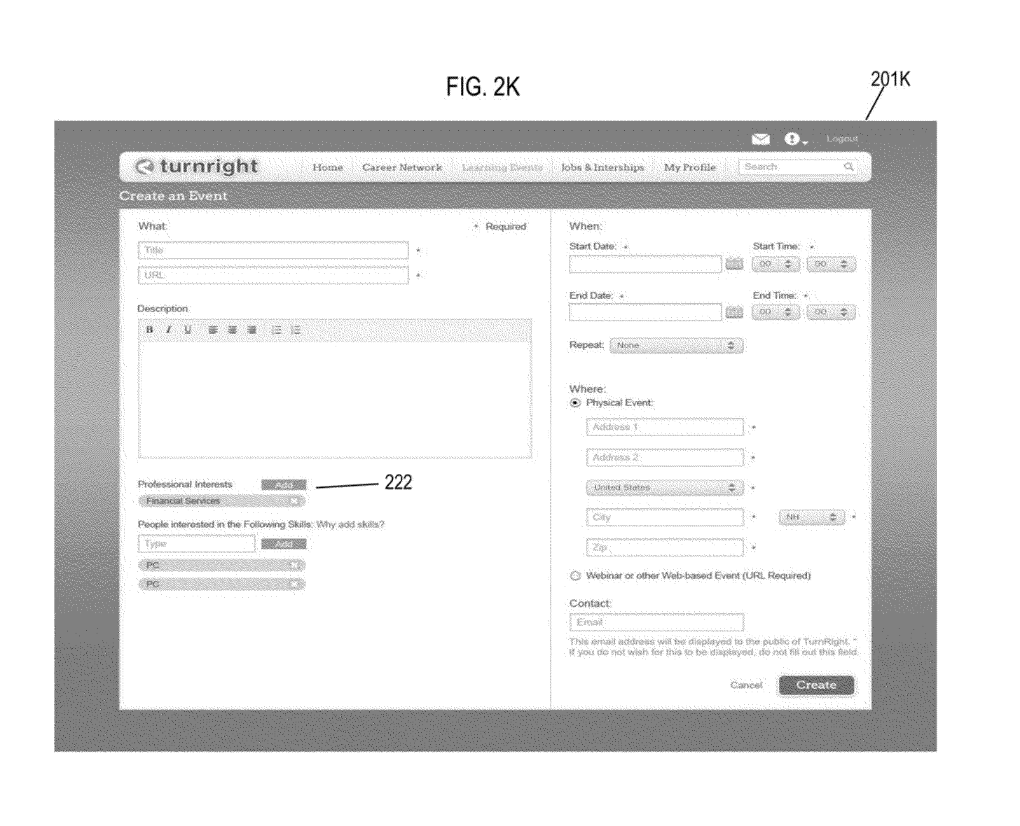

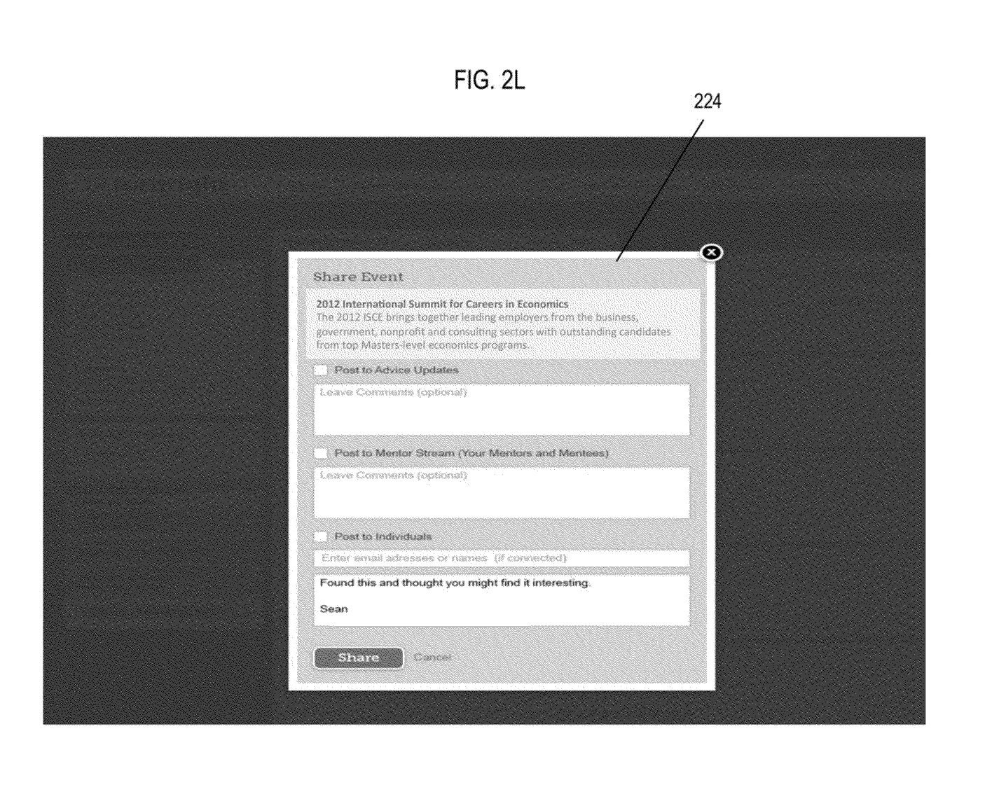

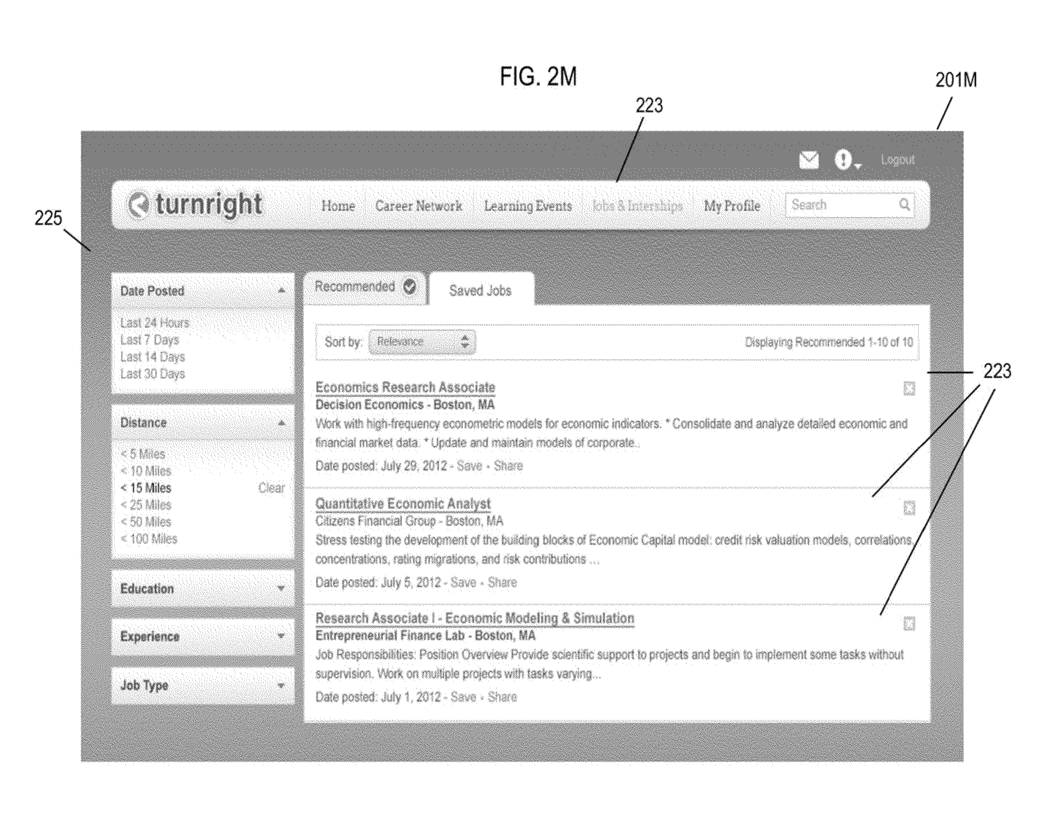

In some embodiments, the college student or any other user may be presented with all of the advice connections recommended by recommendation engine 140 along with additional information about the advice connections. In some embodiments, visual roadmap generator 150 may generate roadmaps 45 as a form of additional information about the advice connections. Visual roadmap generator 150 may utilize user data 20, 22 input into system 100 by the users to generate roadmaps 45. In some embodiments, user data 20, 22 may be information user has input into system 100 about the user's achievements in various categories, e.g., job, volunteer, internship, education, personal, activity, awards, and others. Examples of achievements may be job promotions, volunteer work, attainment of bachelor's and/or advanced degrees, hobby achievements, military service, etc. Dates and descriptions associated with the achievements may be included in the user data 20, 22. Visual roadmap generator 150 may utilize the achievements, dates, descriptions, and other relevant information to generate a visual representation of the information. In some embodiments, this visual representation may include one or more timelines. In some embodiments, each achievement may be represented by an icon on the timeline based on the date associated with the achievement. In various embodiments, when the user selects the icon, the description of the achievement may be presented to the user, as will be discussed in further detail with respect to FIG. 2. In various embodiments, visual roadmap generator 150 may generate and present a visual roadmap 45 for each advice connection that is recommended by recommendation engine 140. The visual roadmaps for the advice connections may present a way for the college student, or any other user, to quickly and easily learn more about any particular advice connection.

In some embodiments, a college student or any other user may identify one or more recommended advice connections who they think may be a useful resource. In some embodiments, this identification may be made based on the visual roadmaps of the recommended advice connections. The college student may choose an advice connection based on the job the advice connection currently holds, the activities the advice connection has participated in, the kind of education the advice connection has received, or any other information available about the advice connection. In various embodiments, the college student may be able to designate the recommended advice connection that they wish to further pursue as a resource. In some embodiments, user may be able to “follow” or subscribe to these advice connections by choosing to track activity of the advice connection in system 100. For example, in various embodiments, system 100 may include a website which presents the various outputs of system 100. Each user of system 100 may have a page of the website that displays an aggregate feed of the other users being followed or subscribed to by the user. This feed may display a constant update of activity associated with the users being followed. The activity may be activity within system 100 or activity in their lives. As examples, the feed may display when the users are attending an event, subscribing to another user, posting an advice article, hosting a training session, updating an achievement, changing careers, etc.

In some embodiments, a college student or any other user subscribes to an advice connection by subscribing to an advice stream associated with the advice connection. The advice stream may be a running collection of advice generated by the advice connection. Advice stream module 160 may generate advice streams 50 of advice connections based on user data 22 input from the advice connections. The user data 22 may include advice articles or posts written by the user. In some embodiments, user data 22 may also include activity by the user inside system 100. For example, an advice connection may find an event 25 that they consider useful and interesting, and designate or “like” the event as useful and interesting. As another example, advice connection may input an event 25 or job opportunity 30 into system 100. These activities may be reflected in the advice stream 50 of the advice connection. Other activities or actions of the advice connection that may have advice value to other user may be included in advice stream 50. In various embodiments, any elements that may be part of advice stream 50 of an advice connection may be incorporated into the college student's aggregate feed if the college student subscribes to the advice connection.

In some embodiments, users may be able to vote or score the advice stream 50 for the quality of the advice stream. In various embodiments, the vote may be a binary “like”/“dislike” choice. In other embodiments, the vote may include several possible choices, or may include several qualities to vote on, e.g., inspirational, useful, innovative. In various embodiments, advice stream module 160 may accumulate the votes 35 and output an accumulative score associated with the advice stream 50. Users may then be able to make a decision to subscribe to or read advice streams 50 based on the accumulated scores of the advice stream.

In some embodiments, advice streams may include interactive elements that allow a college student subscribing to the advice stream 50 to develop a relationship with the advice connection of the advice stream. For example, the college student may be able to post comments or questions to the advice connection in response to the contents of the advice stream, to which the advice connection may in turn respond. In other embodiments, the college student may be able to “like” certain contents of the advice stream, letting the advice connection know that the college student is interested in those specific things. Eventually, these interactions may lead to the advice connection and the college student entering into a mentoring relationship. This mentoring relationship may involve, for example, the advice connection providing specific advice tailored to the college student, providing a connection to a job opportunity, and/or other forms of mentoring facilitated by system 100.

Some embodiments of system 100 may include websites, software, databases, computer processors, hard drives, user display terminals, input devices, wired and wireless communication devices, memory modules, and/or a combination thereof. Some embodiments of system 100 may be implemented on an intranet, on the world wide web, or any other form of a network. Some exemplary embodiments of system 100 that include website interfaces are now described in detail while referring to FIGS. 2A-2M.

FIG. 2A illustrates an exemplary screen shot of a webpage 201A for some embodiments of system 100. Webpage 201A may be one webpage of multiple webpages that may be a part of some embodiments of system 100. In some embodiments, there may be a login page (not shown) where users login into their personal accounts within system 100. In other embodiments, there may be a registration page (not shown) where users create personal accounts within system 100. In some embodiments, in the registration process, webpage 201A may be presented to a user where the user may choose one or more vocational interests 202 as representative of the user's interests. In some embodiments, the user may select one, two, or three vocational interests from the list. For example, in the embodiment shown in FIG. 2A, the user is allowed to choose up to three vocational interests. The vocational interests that the user has selected may be indicated by a darker color as shown. In other embodiments, the user may select a different number of vocational interests from the list. In various embodiments, the vocational interests that the user may choose may be as those reflected on webpage 201A. In other embodiments, the vocational interests that the user may choose may be partially or wholly different from those reflected on webpage 201A. In some embodiments, webpage 201A may be accessed not only during a registration process, but any other time at which the user may wish to update or change the vocational interests associated with the user. In some embodiments, the vocational interests on webpage 201A that have been selected by the user may be used by interest vector generator 110 to generate a user interest vector 6 and/or resource interest vector 8.

FIG. 2B illustrates an exemplary screen shot of a portion of webpage 201B for some embodiments of system 100. Webpage 201B may be associated with a specific user of system 100 and may include an aggregate feed 204 that includes updates from advice streams of advice connections to which the user has subscribed, as well as updates of activities of any other person that the user follows. In some embodiments, aggregate feed 204 may be generated by advice stream module 160. In the aggregate feed, the user has the option of posting their own comments and updates in the text box 204a, which then appears in the feed stream as post 204b. Other users' posts 204c are also displayed. Other users may post comments in response to the user's post 204b, to which the user may in turn respond with a comment 204d. In some embodiments, the aggregate feed 204 may be considered an advice stream to which other users may subscribe. Webpage 201B also displays recommendations 209 generated by recommendation engine 140 as described above. Recommendations 209 includes advice connection recommendations 210, and may also include event recommendations (not shown) and job opportunity recommendations (not shown). In the screen shot depicted in FIG. 2B, the webpage is indicating that there are eight advice connection recommendations that system 100 is recommending to the user. The number of advice connection recommendations 210 may be updated whenever the user logs into system 100, at regular intervals, or in any other manner known in the art. In some embodiments, the user may be able to click on advice connection recommendations 210 for a more detailed report of the recommendations. In some embodiments, clicking on advice connection recommendations 210 may result in system 100 presenting to the user a webpage like the one shown in FIG. 2F, which is discussed later.

FIG. 2C illustrates an exemplary screen shot of a portion of webpage 201C for some embodiments of system 100. Webpage 201C includes a photo of the user 203. In this example, the user is a affiliate (an alum), but in other embodiments, user 203 may be a college student. Webpage 201C also includes a roadmap 206 of achievements associated with user 203. Roadmap 206 includes achievement category buttons 207 representing different categories of achievements and achievement icons 208 representing various achievements of user 203. In various embodiments, roadmap 206 may be generated by roadmap generator 150, and achievements associated with user 203 may be input as part of user data 20, 22 and stored in user database 120A. In the example of webpage 201C, there are five achievement category buttons 207 being shown that represent personal, educational, job, activity, and award/certification categories. In addition, many achievement icons 208 are shown on multiple timelines 211A, 211B, 211C, and 211D, where each timeline represents one of the achievement categories 207. For example, 211A represents a timeline of user 203's achievements in education and the icons on time 211A indicate that there were two achievements in this category. In one example, the first educational achievement icon may represent graduation from college, and the second educational achievement icon may represent graduation from graduate school. On the other hand, timeline 211B represents a timeline of user 203's achievements in the jobs and internships categories. There are numerous work achievements that user 203 has accomplished as indicated by the six work achievement icons on timeline 211B. These achievements may be obtaining a job, getting promoted, changing jobs, etc. While roadmap 206 in FIG. 2C is depicted as having multiple timelines, it is contemplated that roadmap 206 does not have to be presented in this “expanded” form. In some embodiments, roadmap 206 may be “collapsed” to have only one timeline that depicts achievement icons 208 of various achievement categories 207 on one line. In some embodiments, a user viewing the roadmap can switch between the expanded view and the collapsed view.

Webpage 201C includes a scroll arrow 206A at one end of the row of achievement category icons 207. In some embodiments, this scroll arrow indicates that there are more achievement categories that are not presently being shown. When a user who is viewing roadmap 206 selects the scroll arrow 206A, webpage 201C may update to reveal the other achievement categories 207 that were previously hidden. FIG. 2D illustrates this updated webpage, where additional achievement category icons 207 representing internship, volunteer, and military service achievements are shown in roadmap 206.

Users may use roadmaps 206 like those shown in FIGS. 2C and 2D as a simple, visual way to overview the career path of the user corresponding to the roadmap. In some embodiments, a college student may become specifically interested in another user, perhaps as a potential mentor, based on the information presented by the roadmap. In other embodiments, if the roadmap belongs to a affiliate with a job that the college student is interested in also obtaining, the college student may use the roadmap as a guide or reference for what the college student may want to achieve to obtain that same type of job. In various embodiments, further information about achievements represented by achievement icons 208 may be revealed when the user selects achievement icons 208. In various embodiments, the detailed information about the achievements can be displayed in various manners, for example, as a floating text bubble, on a different webpage, or in any other manner known in the art.

FIG. 2E illustrates roadmap 206 corresponding to user 203 that may be edited by user 203. In some embodiments, user 203 may add new achievements to their own roadmap 206 or edit details of preexisting achievements as shown in FIG. 2E. The user may simply specify the type of achievement, which is a job achievement in the example shown in FIG. 2E, and the date the achievement occurred. The user may also choose to include additional information about the achievement, for example, the position, the company, a detailed description of the achievement, and/or other information, which would then be available for other users to view with the roadmap. For example, if the job achievement being edited in the edit section 212 of FIG. 2E corresponds to the job achievement icon 208A, when another user selected job achievement icon 208A, the detailed information input into edit section 212 would become available to the viewing user.

FIG. 2F depicts a screen shot of a portion of an exemplary webpage 201F for some embodiments of system 100 that displays recommended advice connections 210 generated by recommendation engine 140 for a user 203 of system 100. Associated with each recommended advice connection 210 are options to follow the advice connection 213, to see recent updates 214, and to view the roadmap of the advice connection 215. In some embodiments, recent updates may be recent contents of the advice connection's advice stream. In some embodiments, choosing to view roadmap may display the roadmap of achievements of the advice connection on webpage 201F or on another webpage. Webpage 201F also displays details associated with each advice connection 210 that may come from the user data 20 of the advice connection, e.g., whether they are an alumni/ae or a student or some other affiliate and their academic major or current employer. Webpage 201F also displays several lists 216 of mentors, mentees, followers, and followees of the user 203 under several tabs. A viewing user may select different tabs to be able to view the users that fall under these categories of connections of user 203.

FIG. 2G depicts a screen shot of a portion of an exemplary webpage 201G for some embodiments of system 100 that displays a notifications tab 217. Notifications tab 217 indicates when other users of system 100 have generated activity that is associated with user 203, e.g., when another user has decided to follow user 203, commented on a post by user 203, “liked” a post by user 203, etc.

FIG. 2H depicts a screen shot of a portion of an exemplary webpage 201H for some embodiments of system 100 that displays a mentor requests tab 218. Mentor requests tab 218 notifies user 203 when another user has proposed that a mentoring relationship be set up between user 203 and the proposing user. The other user may send a message to user 203 explaining why they are interested in a mentoring relationship with user 203 or any other relevant communication. User 203 can either opt to decline or accept the request by selecting either button 218a or 218b.

FIG. 2I depicts a screen shot of an exemplary webpage 201I for some embodiments of system 100 that displays learning events 219 under a learning events section 220. Webpage 201I displays two tabs 220a and 220b, where tab 220a may be for a listing of learning events recommended by the recommendation engine 140 and tab 220b may be for a listing the events in which the college student has indicated an interest. For each learning event 219, webpage 201G displays a short description, a location, a time, and the affiliate who posted the learning event. In various embodiments, these and other associated information of learning events may be input as event data 25 and stored in event database 120B. Various filters 221 are available to display subsets of the learning events 219 as specified by the filters. Filters may include dates the learning events were posted, the location of the events, the interests areas corresponding to the events, and/or any other known filter for sorting through the events.

FIG. 2J depicts a screen shot of an exemplary webpage 201J for various embodiments of system 100. Webpage 201J displays detailed information about one specific learning event. In some embodiments, this detailed information may have been input as event data 25 and stored in event database 120B. In some embodiments, webpage 201J may be presented to a user in response to the user selecting one of the events 219 displayed on webpage 201I in FIG. 2I. Webpage 201J includes a web address, times, location, and poster of the learning event. In addition, webpage 201J displays detailed information about the learning event that may help the user determine whether he or she is interested in attending the learning event. Webpage 201J also displays other users who may also be attending the learning event. Based on the list of attendees of the learning event, college student may decide it is valuable to also attend the event for networking purposes.

FIG. 2K depicts a screen shot of an exemplary webpage 201K that displays a form for posting a learning event for various embodiments of system 100. The form on webpage 201K illustrates one embodiment of a method of receiving event data 25. The form may include a field for a title, an associated web address, a description, times, a location, and a contact information for the event. The form may also allow for a user posting the learning event to designate vocational interests that are associated with the event, by the add button 222 of webpage 201K. In other embodiments, the designation may be made by a pull-down menu, radio buttons, or in any other manner known in the art. The user posting the learning event may provide one or more vocational interests which will be used by the interest vector generator 110 to assign an event interest vector to the learning event. In other embodiments, the user may not designate any vocational interests to the event, in which case system 100 may automatically assign vocational interests or an event interest vector to the learning event based on the vocational interests or user interest vector of the user posting the event.

FIG. 2L depicts a screen shot of an exemplary form 224 for sharing a learning event for various embodiments of system 100. Form 224 may be filled out by user 203 to share an event that user 203 may believe is interesting and pertinent to the professional field in which user 203 belongs. In some embodiments, when user 203 shares the learning event, the learning event may be posted in user 203's aggregate update feed 204, in a mentor advice stream that is viewable by mentees of user 203, and/or to specific individuals.

FIG. 2M depicts a screen shot of an exemplary webpage 201M for various embodiments of system 100. Webpage 201M displays job opportunities 223 in a job opportunities section 225. Webpage 201M displays two tabs, one for recommended job opportunities as determined by the recommendation engine of system 100, and the other for job opportunities that the user 203 has designated as job opportunities they are interested in. Various filters 225 are available to display subsets of the job opportunities 223 according to the selection of the filters. As with learning events, system 100 may include other webpages that display details about each of the job opportunities that have been input as job opportunity data 30, the other users who are also interested in those job opportunities, provide a form to post job opportunities, and/or provide a form to inform other users of specific job opportunities.

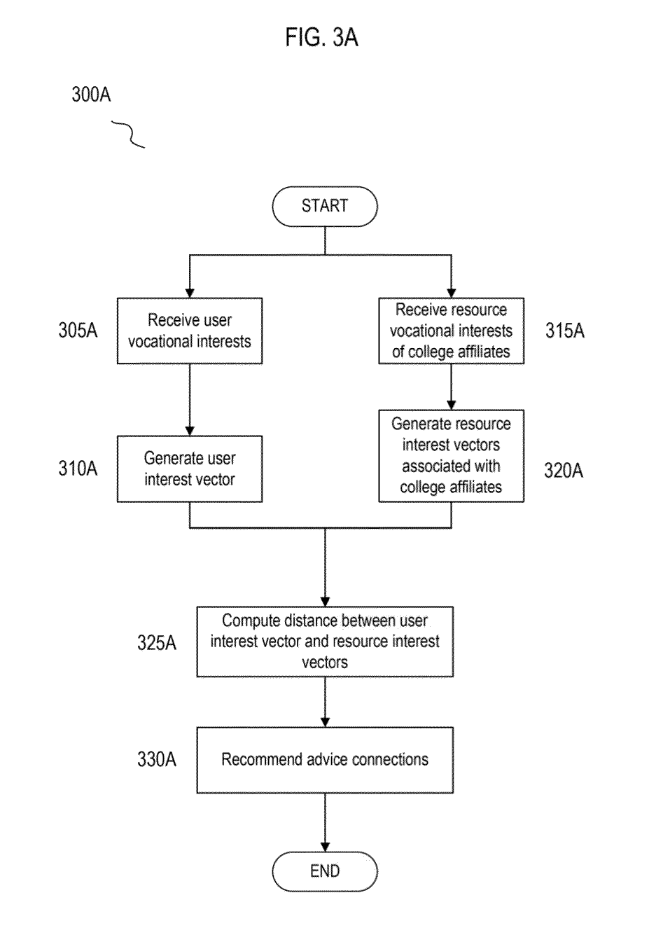

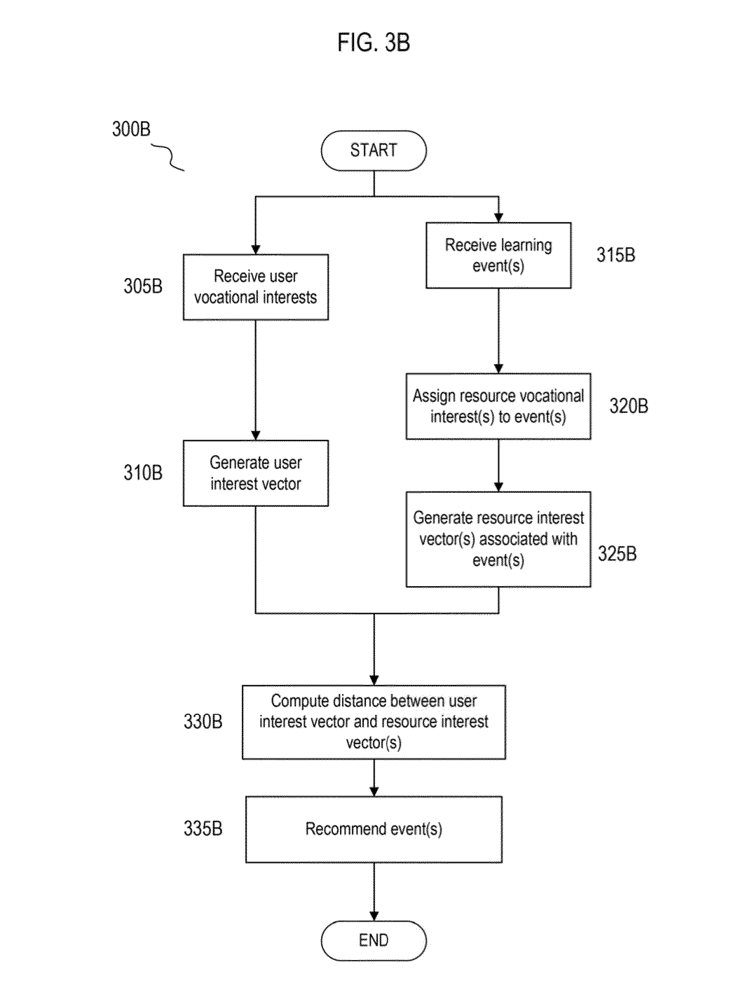

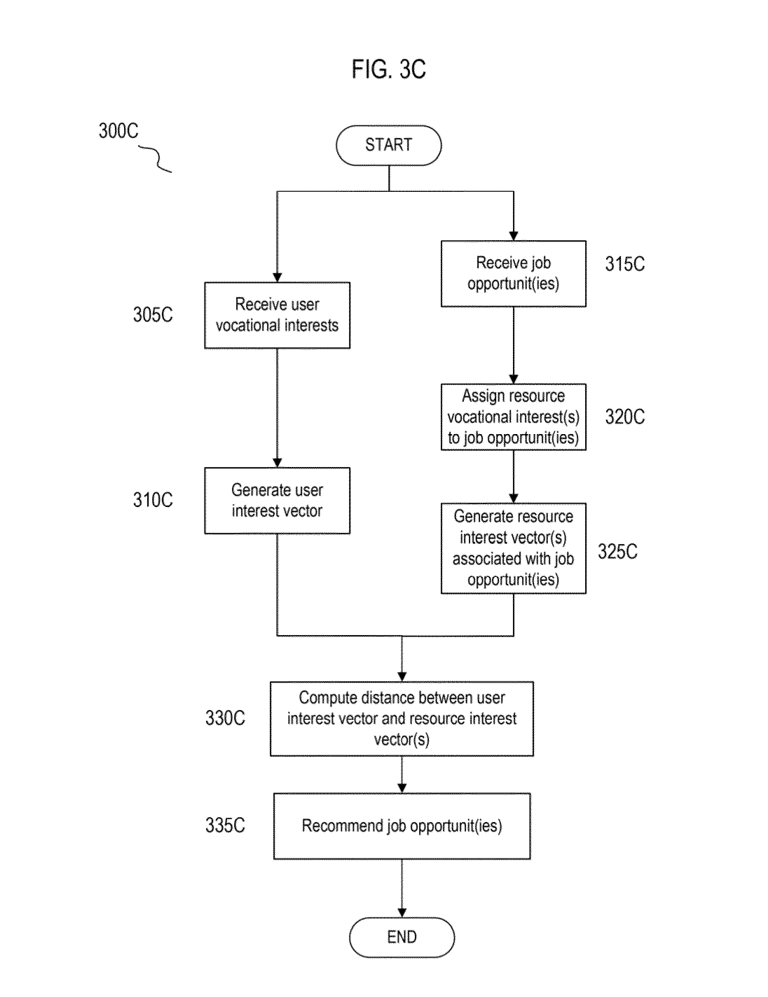

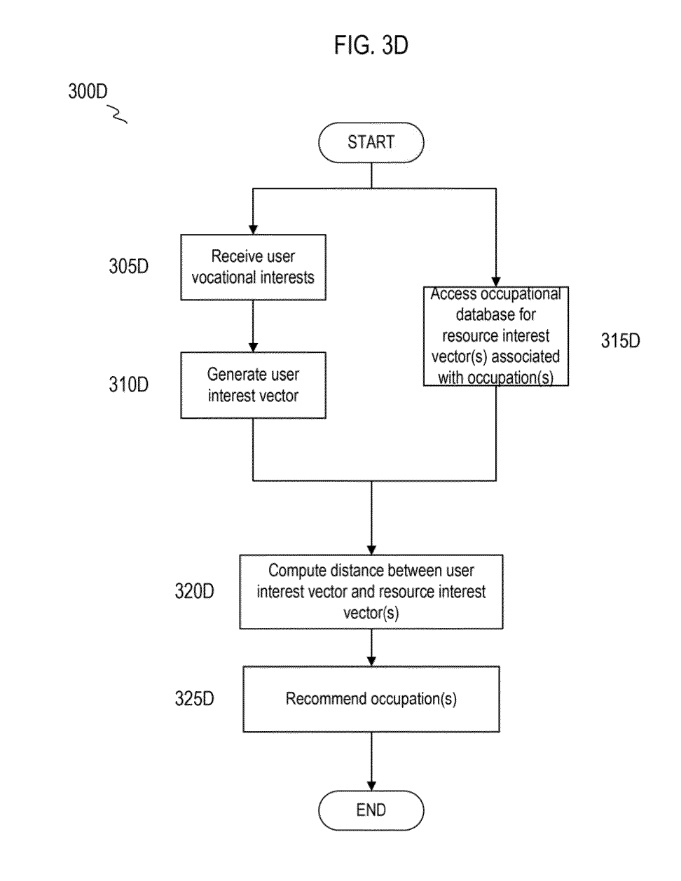

FIGS. 1 and 2 present only exemplary embodiments of system 100 of the disclosure. The details presented with respect to these figures may be altered or omitted without changing the spirit of the disclosure of system 100. Exemplary embodiments of methods that may be performed by system 100 are now discussed with respect to FIG. 3.

FIG. 3A illustrates a flowchart 300A for providing career advice to users. In some embodiments, users may include anyone who is seeking a job or career. In various embodiments, the users may be anyone who is connected with a community or network of users with various levels of job and career experiences. In some exemplary embodiments of this disclosure, the users receiving career advice may be college students (past, present, and/or future). In various embodiments, the steps of flowchart 300A may be performed by a career advice system, for example, system 100.

In step 305A, one or more user vocational interests of a college student may be received. In some embodiments, they may be received through a webpage interface, a computer device interface, a mobile device interface, or any other interface known in the art.

In step 310A, a user interest vector based on the one or more user vocational interests of the college student may be generated. In various embodiments, the user interest vector may be generated by averaging the user vocational interests. In some embodiments, the user interest vector may be normalized to allow for comparison capabilities with other interest vectors. In some embodiments, the user interest vector may be of a Holland interest vector type based on the Holland assessment model. In various embodiments, an interest vector generator may generate the user interest vector. In some embodiments, the user interest vector of the college student may be stored in a user database.

In step 315A, one or more resource vocational interests may be received for each of a plurality of college affiliates, where college affiliates may include other college students as well as other members of the college community, such as alumni/ae, administrator, professors, and industry experts.

In step 320A, a resource interest vector may be generated for each college affiliate based on the one or more resource vocational interests of the college affiliate, similarly to the user interest vector being generated for the college student. In some embodiments, the resource interest vectors of the college affiliates may be of the Holland interest vector type based on the Holland assessment model. In various embodiments, the resource interest vectors of the college affiliates may be stored in the user database. In various embodiments, steps 315A and 320A may be performed prior to, after, or simultaneously with steps 305A and 310A.

In step 325A, a distance may be calculated between the college student's user interest vector and each resource interest vector of each college affiliate. In some embodiments, this distance may be calculated by subtracting the user interest vector from each resource interest vector, and finding the distance between these vectors, as discussed above. In some embodiments, a comparator may calculate the distance between the college student's user interest vector and each college affiliate's resource interest vector. In various embodiments, the comparator may receive or retrieve the user interest vector of the college student and the resource interest vectors of the college affiliates from the user database.

In step 330A, advice connections may be recommended based on the calculated distances of step 325A. In some embodiments, the advice connection may be the one or more college affiliates whose resource interest vectors have the shortest distances to the user interest vector of the college student. In various embodiments, a recommendation engine may generate the recommendation of advice connections. In some embodiments, these recommendations may be presented to the college student through a webpage interface, a computer display interface, a mobile device interface, email notifications, and or any other output interfaces known in the art. In some embodiments, in addition to being presented to the college student, the recommendations may be utilized to present corresponding visual roadmaps and advice streams to the college student.

FIG. 3B illustrates a flowchart 300B as another exemplary method for providing career advice to users according to some embodiments. In some embodiments, users may include anyone who is seeking a job or career. In various embodiments, the users may be anyone who is connected with a community or network of users with various levels of job and career experiences. In some exemplary embodiments of this disclosure, the users receiving career advice may college students.

In step 305B, one or more user vocational interests of a college student may be received, and in step 310B, a user interest vector may be generated based on the one or more user vocational interests of the college student. In step 315B, one or more events may be received. In step 320B, one or more resource vocational interests may be assigned to the one or more events. In some embodiments, the resource vocational interests may be assigned by a user that is inputting or posting the event. In other embodiments, the vocational interests may be automatically assigned based on the vocational interests of the user inputting or posting the event. In step 325B, resource interest vectors associated with the events may be generated based on the one or more resource vocational interests associated with each event. In various embodiments, the event resource interest vectors may be generated by an interest vector generator. In some embodiments, the event resource interest vectors may be of the Holland interest vector type based on the Holland assessment model. In various embodiments, steps 315B, 320B, and 325B may be performed prior to, after, or simultaneously with steps 305B and 310B. In step 330B, distances between a user interest vector of a college student and each of the event resource interest vectors of the one or more events may be computed. In various embodiments, a comparator may compute these distances in a manner similar to the computation of distances between user interest vector of a college student and resource interest vectors of college affiliates. In step 335B, one or more recommendations of events may be made to the college student based on the computed distances between the user interest vector and the event resource interest vectors. In some embodiments, the event recommendations may be the one or more events with event resource interest vectors with the shortest distances to the user interest vector of the college student.

FIG. 3C illustrates a flowchart 300C as another exemplary method for providing career advice to users according to some embodiments. In some embodiments, users may include anyone who is seeking a job or career. In various embodiments, the users may be anyone who is connected with a community or network of users with various levels of job and career experiences. In some exemplary embodiments of this disclosure, the users receiving career advice may be college students.

In step 305C, one or more user vocational interests of a college student may be received, and in step 310C, a user interest vector may be generated based on the one or more user vocational interests of the college student. In step 315C, one or more job opportunities may be received. In step 320C, one or more resource vocational interests may be assigned to the one or more job opportunities. In some embodiments, the resource vocational interests may be assigned by a user that is inputting or posting the job opportunity. In other embodiments, the resource vocational interests may be automatically assigned based on the vocational interests of the user inputting or posting the job opportunity. In step 325C, job opportunity resource interest vectors may be generated based on the one or more resource vocational interests associated with each job opportunity. In various embodiments, the job opportunity resource interest vectors may be generated by an interest vector generator. In some embodiments, the job opportunity resource interest vectors may be of the Holland interest vector type based on the Holland assessment model. In various embodiments, steps 315C, 320C, and 325C may be performed prior to, after, or simultaneously with steps 305C and 310C. In step 330C, distances between a user interest vector of a college student and each of the job opportunity resource interest vectors of the one or more job opportunities may be computed. In various embodiments, a comparator may compute these distances in a manner similar to the computation of distances between user interest vector of a college student and resource interest vectors of college affiliates. In step 335C, one or more recommendations of job opportunities may be made to the college student based on the computed distances between the user interest vector and the job opportunity resource interest vectors. In some embodiments, the job opportunity recommendations may be the one or more job opportunities with job opportunity resource interest vectors with the shortest distances to the user interest vector of the college student.

FIG. 3D illustrates a flowchart 300D as another exemplary method for providing career advice to users according to some embodiments. In some embodiments, users may include anyone who is seeking a job or career. In various embodiments, the users may be anyone who is connected with a community or network of users with various levels of job and career experiences. In some exemplary embodiments of this disclosure, the users receiving career advice may be college students.

In step 305D, one or more user vocational interests of a college student may be received, and in step 310D, a user interest vector may be generated based on the one or more user vocational interests of the college student. In step 315D, an occupational database of a plurality of occupations may be accessed. In some embodiments, each occupation in the database may be associated with an occupation resource interest vector. In some embodiments, the occupation resource interest vectors may be of the Holland interest vector type based on the Holland assessment model. In various embodiments, step 315D may be performed prior to, after, or simultaneously with steps 305D and 310D. In step 320D, a distance may be computed between a user interest vector of a college student and each of the occupation resource interest vectors associated with the occupations stored in the occupational database. In various embodiments, a comparator may compute these distances in a manner similar to the computation of distances between user interest vector of a college student and resource interest vectors of college affiliates. In step 325D, one or more recommendations of occupations may be made to the college student based on the computed distances between the user interest vector and the occupation resource interest vectors. In some embodiments, the occupation recommendations may be the one or more occupations with occupation resource interest vectors with the shortest distances to the user interest vector of the college student.

In various embodiments, one or more of the disclosed elements of system 100 may be implemented via one or more processors executing software programs for performing the functionality of the corresponding element modules. In some embodiments, one or more of the disclosed modules (e.g., interest vector generator, comparator, recommendation engine, advice stream module, visual roadmap generator) are implemented via one or more hardware modules executing firmware for performing the functionality of the corresponding modules. In various embodiments, the disclosed modules or the disclosed storage media are internal or external to the disclosed systems. In some embodiments, one or more of the disclosed modules or storage media are implemented via a computing “cloud,” to which the disclosed system connects via an internet and accordingly uses the external module or storage medium. In some embodiments, the disclosed storage media for storing information include non-transitory computer readable media, such as a CD-ROM, a computer storage, or a flash memory. Further, in various embodiments, one or more non-transitory computer readable media store information, or store software programs that are executed by various modules or that implement various disclosed methods.

The foregoing description of the invention, along with its associated embodiments, has been presented for purposes of illustration only. It is not exhaustive and does not limit the invention to the precise form disclosed. Those skilled in the art will appreciate from the foregoing description that modifications and variations are possible in light of the above teachings or may be acquired from practicing the invention. For example, the steps described need not be performed in the same sequence discussed or with the same degree of separation. Likewise various steps may be omitted, repeated, or combined, as necessary, to achieve the same or similar objectives. Similarly, the systems described need not necessarily include all parts described in the embodiments, and may also include other parts not describe in the embodiments.

Accordingly, the invention is not limited to the above-described embodiments, but instead is defined by the appended claims in light of their full scope of equivalents.

1. A computer-implemented method, performed by one or more computing processors, of providing career advice to a college student, the method comprising:
receiving two or more user vocational interests of the college student, wherein
the two or more user vocational interests are selected by the college student from a list of vocational interests, and
each of the user vocational interests is associated with a vocational interest vector comprising six elements corresponding to Holland codes;
generating, by the one or more computing processors, a user interest vector associated with the college student based on averaging the vocational interest vectors associated with the two or more selected user vocational interests;
receiving two or more affiliate vocational interests of a college affiliate, wherein
the two or more affiliate vocational interests are selected by the college affiliate from a list of vocational interests, and
each affiliate vocational interest is associated with a vocational interest vector comprising six elements corresponding to Holland codes;
generating, by the one or more computing processors, an affiliate interest vector associated with the college affiliate based on averaging the vocational interest vectors associated with the two or more selected affiliate vocational interests;
computing, by the one or more computing processors, a distance between the user interest vector and the affiliate interest vector based on a sum of squares of differences between each element of the user interest vector and a corresponding element of the affiliate interest vector; and
generating a recommendation of an advice connection based on the computed distance.

2. (canceled)

3. The method of claim 1 further comprising:
receiving data associated with an event, input by the college affiliate;
assigning event vocational interests or an event interest vector to the event, wherein the event vocational interests or the event interest vector are the affiliate vocational interests or the affiliate interest vector associated with the college affiliate who inputs the event;
computing a distance between the user interest vector and the event interest vector based on a sum of squares of differences between each element of the user interest vector and a corresponding element of the event interest vector; and
generating an event recommendation based on the computed distance between the user interest vector and the event interest vector.

4. The method of claim 1 further comprising:
receiving data associated with a job opportunity, input by a college affiliate;
assigning job opportunity vocational interests or a job opportunity interest vector to the job opportunity, wherein the job opportunity vocational interests or the job opportunity interest vector are the affiliate vocational interests or the affiliate interest vector associated with the college affiliate who inputs the job opportunity;
computing a distance between the user interest vector and the job opportunity interest vector based on a sum of squares of differences between each element of the user interest vector and a corresponding element of the job opportunity interest vector; and
generating a job opportunity recommendation based on the computed distance between the user interest vector and the job opportunity interest vector.

5. (canceled)

6. (canceled)

7. The method of claim 1 further comprising:
receiving an occupation interest vector associated with an occupation;
computing a distance between the user interest vector and the occupation interest vector based on a sum of squares of differences between each element of the user interest vector and a corresponding element of the occupation interest vector; and
generating an occupation recommendation based on the computed distance between the user interest vector and the occupation interest vector.

8. The method of claim 7, wherein the occupation interest vector is received from an O*NET database.

9. The method of claim 1, wherein the recommendation is based on determining whether the affiliate interest vector has the shortest distance to the user interest vector.

10. (canceled)

11. The method of claim 1 further comprising:
generating a visual roadmap related to the recommended advice connection, comprising one or more graphical timelines of achievements of the recommended advice connection.

12. The method of claim 1 further comprising:
providing an option to follow an advice stream of the recommended advice connection.

13. The method of claim 12 further comprising:
accumulating a score related to the quality of the advice stream wherein the accumulated score is based on votes cast by at least one of the college student and the college affiliate.

14. A system for providing career advice to a college student, implemented by one or more computing processors, the system comprising:
an interest vector generator module, implemented by the one or more processors, configured to:
receive user vocational interests associated with the college student, wherein
the user vocational interests are selected by the college student from a list of vocational interests, and
each of the user vocational interests is associated with a vocational interest vector comprising six elements corresponding to Holland codes;
generate a user interest vector associated with the college student based on averaging the vocational interest vectors associated with the selected user vocational interest;
receive affiliate vocational interests associated with a college affiliate, wherein
the affiliate vocational interests are selected by the college affiliate from a list of vocational interests, and
each of the affiliate vocational interests is associated with a vocational interest vector comprising six elements corresponding to Holland codes; and
generate an affiliate interest vector associated with the college affiliate based on averaging the vocational interest vectors associated with the selected affiliate vocational interests;
one or more databases for storing the user interest vector and the affiliate interest vector;
a comparator module, implemented by the one or more computing processors, which is configured to compute a distance between the user interest vector and the affiliate interest vector, based on a sum of squares of differences between each element of the user interest vector and a corresponding element of the affiliate interest vector; and
a recommendation engine module configured to generate an advice connection recommendation based on the computed distance between the user interest vector and the affiliate interest vector.

15. (canceled)

16. The system of claim 14, wherein
the interest vector generator module is further configured to assign event vocational interests or an event interest vector to an event, the event being input by the college affiliate, wherein
the event vocational interests or the event interest vector are the affiliate vocational interests or the affiliate interest vector associated with the college affiliate who inputs the event;
the comparator module is further configured to compute a distance between the user interest vector and the event interest vector based on a sum of squares of differences between each element of the user interest vector and a corresponding element of the job opportunity interest vector; and
the recommendation engine module is further configured to generate an event recommendation based on the computed distances between the user interest vector and the event interest vector.

17. The system of claim 14, wherein
the comparator module is further configured to access an occupational database storing a plurality of occupations with associated occupation interest vectors, and to compute distances between the user interest vector and the occupation interest vectors, wherein
the distances are based on a sum of squares of differences between each element of the user interest vector and a corresponding element of one of the occupation interest vectors;
and the recommendation engine module is further configured to generate an occupation recommendation based on the computed distances between the user interest vector and the occupation interest vectors.

18. (canceled)

19. The system of claim 14, wherein the advice connection recommendation is based on a determination of whether the affiliate interest vector has the shortest distance to the user interest vector.

20. (canceled)

21. The system of claim 14, further comprising
a visual roadmap generator configured to generate a visual roadmap related to the recommended advice connection, comprising one or more graphical timelines of achievements of the recommended advice connection; and
an advice stream module configured to generate an advice stream related to the recommended advice connection.

22. A non-transitory computer readable storage medium storing a program that when executed causes a one or more processors to perform a method of providing career advice to a college student, the method comprising:
receiving two or more user vocational interests of the college student, wherein
the two or more user vocational interests are selected by the college student from a list of vocational interests, and
each of the user vocational interests is associated with a vocational interest vector comprising six elements corresponding to Holland codes;
generating, by the one or more processors, a user interest vector associated with the college student based on averaging the vocational interest vectors associated with the two or more selected user vocational interests;
receiving two or more affiliate vocational interests of a college affiliate, wherein
the two or more affiliate vocational interests are selected by the college affiliate from a list of vocational interests, and
each affiliate vocational interest is associated with a vocational interest vector comprising six elements corresponding to Holland codes;
generating, by the one or more processors, an affiliate interest vector associated with the college affiliate, based on averaging the vocational interest vectors associated with two or more selected affiliate vocational interests;
computing, by the one or more processors, a distance between the user interest vector and the affiliate interest vector based on a sum of squares of differences between each element of the user interest vector and a corresponding element of the affiliate interest vector; and
generating an advice connection recommendation based on the computed distance.

23. (canceled)

24. The medium of claim 22, wherein the method further comprises:
receiving data associated with an event, input by the college affiliate;
assigning event vocational interests or an event interest vector to the event, wherein the event vocational interests or the event interest vector are the affiliate vocational interests or the affiliate interest vector associated with the college affiliate who inputs the event;
computing a distance between the user interest vector and the event interest vector based on a sum of squares of differences between each element of the user interest vector and a corresponding element of the event interest vector; and
generating an event recommendation based on the computed distance between the user interest vector and the event interest vector.

25. (canceled)

26. (canceled)

27. The medium of claim 22, wherein the method further comprises:
receiving an occupation interest vector associated with an occupation;
computing a distance between the user interest vector and the occupation interest vector based on a sum of squares of differences between each element of the user interest vector and a corresponding element of the occupation interest vector; and
generating an occupation recommendation based on the computed distance between the user interest vector and the occupation interest vector.

28. (canceled)

29. The medium of claim 22, wherein the method further comprises generating a visual roadmap related to the recommended advice connection, comprising one or more graphical timelines of achievements of the recommended advice connection.

30. The medium of claim 22, the method further comprises providing an option to follow an advice stream of the recommended advice connection.

31. The system of claim 14, wherein
the interest vector generator module is further configured to assign job opportunity vocational interests or a job opportunity interest vector to a job opportunity, the job opportunity being input by the college affiliate, wherein
the job opportunity vocational interest or the job opportunity interest vector are the affiliate vocational interests or the affiliate interest vector associated with the college affiliate who inputs the job opportunity;
the comparator module is further configured to compute a distance between the user interest vector and the job opportunity interest vector based on a sum of square of differences between each element of the user interest vector and a corresponding element of the job opportunity interest vector; and
the recommendation engine module is further configured to generate an job opportunity recommendation based on the computed distances between the user interest vector and the job opportunity interest vector.

32. The method of claim 22, wherein the method further comprises:
receiving data associated with a job opportunity, input by the college affiliate;
assigning job opportunity vocational interests or a job opportunity interest vector to the job opportunity, wherein the job opportunity vocational interests or the job opportunity interest vector are the affiliate vocational interests or the affiliate interest vector associated with the college affiliate who inputs the job opportunity;
computing a distance between the user interest vector and the job opportunity interest vector based on a sum of squares of differences between each element of the user interest vector and a corresponding element of the job opportunity interest vector; and
generating a job opportunity recommendation based on the computed distance between the user interest vector and the job opportunity interest vector.
